(19) United States
(12) Patent Application Publication
(10) Pub. No.: US 2013/0132379 A1
(43) Pub. Date: May 23, 2013

(54) IDENTIFICATION AND SELECTION OF AT LEAST ONE CORD BLOOD UNIT FOR TRANSPLANTATION

(71) Applicant: Thomas Klein, Potsdam (DE)

(72) Inventor: Thomas Klein, Potsdam (DE)

(73) Assignee: CYTOLON AG, Berlin (DE)

(21) Appl. No.: 13/699,147

(22) PCT Filed: May 20, 2011
(86) PCT No.: PCT/EP11/58242

§ 371 Date: Feb. 7, 2013

(30) Foreign Application Priority Data
May 20, 2010 (EP) 10075215.3

(51) Int. Cl. G06F 19/00

(52) U.S. Cl. CPC G06F 19/32
USPC 707/723

(57) ABSTRACT

The invention describes a method for the identification and selection for at least one cord blood unit for a transplantation.

### FIELD OF INVENTION

The invention relates to a method and a system for the identification and selection of at least one cord blood unit for a transplantation.

### BACKGROUND OF THE INVENTION

Umbilical cord blood is playing an important and growing role in the treatment of leukemia, lymphoma and other life-threatening blood diseases.

Umbilical cord blood is one of three sources for the blood-forming cells used in transplants. The other two sources are bone marrow and peripheral (circulating) blood. The first cord blood (CB) transplant was done in 1988. Cord blood plays an important role in transplant today. The umbilical cord blood is collected from the umbilical cord and placenta after a baby is born. This blood is rich in blood-forming cells.

After the donation, the cord blood is tested, frozen and stored at a cord blood bank for future use. The stored cord blood is called a cord blood unit (CBU).

Like bone marrow, cord blood is rich in the blood-forming cells that can be used in transplants for patients with leukemia, lymphoma and many other life-threatening diseases. When a patient needs a transplant, his or her doctor will decide what the best source of blood-forming cells is. If the best choice is to use the patient's own cells for transplant, the cells are usually collected from the patient's bloodstream before the transplant (autologous cell transplant). However, if the best choice is to use donated cells for transplant, the doctor will look for a donor or a cord blood unit with a tissue type that matches the patient's as closely as possible (allogeneic cell transplant). A patient's best chance of finding a match is with a brother or sister. If a brother or sister is a match, the cells for transplant can be collected from that sibling's bone marrow or peripheral blood or cord blood unit.

But 7 out of 10 people will have to look outside their family because there is not a suitably matched person within their family. Those patients depend on the established cord blood banks to find an unrelated bone marrow donor or umbilical cord blood unit. Doctors search the registry of the cord blood bank of adult marrow or peripheral blood cell donors and cord blood units to find a suitable HLA match for their patients who need a transplant. If selected, the matching cord blood is transplanted to a patient. The transplant process is the same as for marrow and peripheral blood cell transplants. However, the databases of the cord blood banks are not continuously updated and no direct ordering/delivering of the CBU can be performed by the doctor.

There are currently four modalities of cord blood collection and storage. With the first, “family” cord blood banking—cord blood is collected from the baby for primary use by the child and 1st and 2nd degree relatives. The family usually pays the bank for processing and storage of the CB sample. For profit companies operate the banks and, in the case of the larger banks, collect cord blood on a national scale using a network of collecting physicians, hospitals, and field representatives. Mothers are made aware of this option through consumer and professional channel marketing. The collected cord blood sample is the property of the family.

With the second, “public” cord blood banking—cord blood is collected for processing and storage in an anonymous bank. Samples are used in an allogeneic setting and require donor/host genetic matching prior to clinical use. Public banks are not for profit institutions, supported largely by grants, and operate in a small number of regional hospitals proximate to the bank itself. Mothers are made aware of this option at the time of birth, or shortly before, and the cord blood is collected by staff members who are typically direct staff of the public bank and resident at the regional hospital. There is a limited ability to collect cord blood with specific characteristics, such as sample size, ethnic background, family health history, etc. owing to the limited hospital/donor reach and information window available. The collected cord blood sample is the property of the public bank.

With the third, known as a Designated Transplant Banking (DTB)—cord blood is collected from the baby for primary use by a 1st degree relative already identified with a disease for which the baby's cord blood stem cells may provide a viable therapeutic option. There is no charge to the family for this service. The cord blood sample is typically the property of the DTB.

With the fourth, known as Emergency Cord Blood Banking (also known as Low APGAR Collection and various other names)—cord blood is collected from the baby based on a metric determined at the time of birth by the physician, such as a low APGAR score, or other metric which may be predictive of a condition for which the collected stem cells may be of therapeutic value for the child. There is a nominal charge to the family. The cord blood sample is the property of the “Family” bank for a period of time and can then revert to the parents in a “conversion” to family banking. Current federal regulations restrict Family banks from operating as Public banks and Public banks are restricted from Family banking by charter, funding sources, and an inability to be competitive in Family banking. This results in substantial inefficiencies on both sides. The Family banks can not leverage their highly efficient, high volume, collection and processing systems to lower the per sample cost of publicly banked samples, and the public banks are forced into a highly inefficient collection system involving direct staff at limited regional hospitals. The public banks are also constrained relative to the characteristics of the cord blood they can collect as discussed above.

Various procedures and methods of allocating umbilical cord blood (UCB) preparations between collection centers and cord blood banks on the one hand and hospitals and transplant centers on the other hand have emerged in recent years. All of these procedures and methods have their origin in processes required in the allocation of bone marrow. However, no automated processes are available as yet. A hospital in need of a UCB preparation intended for a patient/recipient for transplantation would make inquiries with registers as to whether they have a UCB preparation available for their patient that correspondingly complies with a number of biological and medical characteristics. For ex-ample, the registered data may relate to the so-called HLA match or to the number of cells present in the preparation, or other medical or biological data (e.g. blood group).

Hospitals and transplant centers have so-called coordinators who perform the selection of a particular UCB transplant with reference to the submitted data. The coordinators suggest a selection of preparations to the attending physician. The physician decides which, if any, transplant will be used. For each preparation, the hospital is required to inquire all important data relating to the respective preparation so as to be able to order the proper cord blood unit. However, no worldwide standards have been defined for information deposited in a so-called Unit Report. Also, no correlation between data of individual preparations has been made as yet. When selecting preparations, coordinators are subject to an iterative process which is time-consuming and prone to error.

There is no description in the prior art relating to the exact process of selecting the preparations. It is generally known which parameters should be used at minimum to select suitable preparations, but it is not possible to deduce the “best” preparation from the analyzed preparations. Furthermore, there is no description in the prior art relating to a selection system which selects a suitable preparation and presents the result to the coordinator accordingly and can optionally proceed in an automated fashion. The prior art discloses that the selection of suitable preparations is primarily made on the basis of HLA typing and provides essentially no further criteria.

Also, the prior art does not disclose any solutions to multiple transplantations. This is a solution strategy used in the event that no suitably large preparation can be found. The search problem is then extended to two or more preparations which together include sufficient cells and also have sufficiently matching HLA values both among each other and with respect to the patient.

### SUMMARY OF THE INVENTION

In light of the prior art the technical problem underlying the present invention is to provide a system or method to allow the search of a cord blood bank in an efficient and fast way.

This problem is solved by the features of the independent claims. Preferred embodiments of the present invention are provided by the dependent claims.

The invention therefore relates to a method for the identification and selection for at least one cord blood unit for a transplantation, comprising:
a. input of serological and/or molecular codes of HLA loci, allele type and further criteria of the cord blood unit,
b. input of serological and/or molecular codes of HLA loci and allele type and further criteria of a recipient,
c. conversion of the inputs according to a. and b. into a standardized nomenclature,
d. generation of a search vector, which contains all possible values matching the serological and/or molecular nomenclature of the HLA loci and allele type of the recipient, and wherein a possible value is assigned a ranking that determines where a unit appears in the results list, and wherein the ranking depends on the match between the HLA loci and allele type of the possible unit and the recipient,
e. comparing the HLA loci and allele type of the search vector with a,
f. generation of a list comprising possible cord blood units for the recipient together with the previously determined ranking in the search vector,
g. filtering the list in accordance to a set of defined criteria,
h. grouping the possible units according to the match grade and
i. sorting the units in accordance with at least the match grade.

It is also preferred to sort the units in accordance with further values such as, TNC, TNC coverage, CD34+ cells or volume. The units can be sorted based on only one or more values. The invention further relates to a system for the identification and selection for at least one cord blood unit for a transplantation, comprising:
a. input of serological and/or molecular codes of HLA loci, allele type and further criteria of the cord blood unit via an input element, such as a keyboard in a computer and storing on a storage medium,
b. input of serological and/or molecular codes of HLA loci and allele type and further criteria of a recipient via an input element in a computer and storing on a storage medium,
c. conversion of the inputs according to a. and b. into a standardized nomenclature,
d. generation of a search vector, which contains all possible values matching the serological and/or molecular nomenclature of the HLA loci and allele type of the recipient, and wherein a possible value is assigned a ranking that determines where a unit appears in the results list, and wherein the ranking depends on the match between the HLA loci and allele type of the possible unit and the recipient, particularly the storage of said search criteria on a storage medium and/or a processing unit,
e. comparing the HLA loci and allele type of the search vector with a,
f. generation of a list comprising possible cord blood units for the recipient together with the previously determined ranking in the search vector,
g. filtering the list in accordance to a set of defined criteria,
h. grouping the possible units according to the match grade and
i. sorting the units in accordance with at least the match grade.

The system can provide in particular umbilical cord blood preparations, for transplantations, therapies and/or research purposes between at least one collection center and/or storage site and at least one clinic, transplant center and/or research facility, the latter communicating with each other via wired and/or wireless connections on one or more processing units, especially computers, medical systems, storage devices and/or special processors, and being connected via a network of said multiple processing units by means of which data are exchanged.

Human leukocyte antigen (HLA) typing is preferably used to match patients and donors for bone marrow or cord blood transplants (also called BMT). HLA are proteins—or markers—found on most cells in your body. The immune system uses these markers to recognize which cells belong in the body and which do not.

A close match between the HLA markers and the donors can reduce the risk that the immune cells will attack the donors cells or that the donors immune cells will attack the body of the recipient after the transplant.

It has been shown, that a close HLA match improves the chances for a successful transplant, promotes engraftment, reduces the risk of a post-transplant complication called graft-versus-host disease (GVHD).

It is preferred that the loci is chosen from the group comprising HLA-A, -B, -C, -DR, -DP and -DQ.

It is also preferred that the criteria comprises data about the cord blood donor, the cord blood unit and the recipient selected from the group comprising ethnicity, accreditation, blood group, rhesus factor, diseases, genetic defects, cord blood unit age, volume of cord blood.

Furthermore, the molecular codes are preferably categorized in a standardized nomenclature comprising
a. high resolution, in which the allele is directly specified,
b. medium resolution, in which a range of possible values is given and
c. low resolution, in which only the HLA locus and allele type is specified.

The serological codes are also preferably categorized in a standardized nomenclature comprising
a. antigen,
b. broad,
c. split and
d. associate.

It is preferred that molecular codes can be compensated by serological codes and vice versa.

The method can preferably identify cord blood units for an allotransplantation.

It is preferred that the identified cord blood units can be combined to multicord transplants. Advantageously, the identified matching units can be combined to double- or multicord transplants. The preferred method and system can be used to identify cord blood units which perfectly fit and which can be used for multicord transplantations.

The invention also relates to a system for the identification and selection for at least one cord blood unit for a transplantation, comprising:
a. input of serological and/or molecular codes of HLA loci, allele type and further criteria of the cord blood unit,
b. input of serological and/or molecular codes of HLA loci and allele type and further criteria of a recipient,
c. conversion of the inputs according to a. and b. into a standardized nomenclature,
d. generation of a search vector, which contains all possible values matching the serological and/or molecular nomenclature of the HLA loci and allele type of the recipient, and wherein a possible value is assigned a ranking that determines where a unit appears in the results list, and wherein the ranking depends on the match between the HLA loci and allele type of the possible unit and the recipient,
e. comparing the HLA loci and allele type of the search vector with a,
f. generation of a list comprising possible cord blood units for the recipient together with the previously determined ranking in the search vector,
g. filtering the list in accordance to a set of defined criteria, based on parameters of the cord blood unit and/or the recipient,
h. grouping the possible units according to the match grade and
i. sorting the units in accordance with at least the match grade.

It is also preferred that the cord blood units are characterized by the following parameters:
name and identification of the UCB storage bank (UCB bank),
status of the UCB storage bank with regard to international certifications, preferably FACT,
process reliability of the UCB bank according to classification,
contact in the respective bank, including contact data,
identification number of preparation,
medical history of mother, child and family according to anamnesis form of the maternity clinic,
ethnic group of mother, father and/or child,
sex of child,
date of initial storage of preparation,
details of preparation processing,
blood group of preparation,
HLA type of preparation,
cell count (TNC) of preparation,
cell count (CD34+) of preparation,
viral status of preparation,
allelic characteristics of preparation, and/or
parameters of molecular diagnoses and analyses,
said data set being stored on a storage medium and/or processing unit.

In a preferred embodiment, the recipient is characterized by the following parameters:
name and identification of clinic or transplantation center,
names of coordinator and attending physician, including contact data,
status of clinic with regard to international certifications (e.g. FACT),
average number of UCB transplantations in the inquiring clinic during the last three years,
name of patient, insurance number and other accounting information,
patient's medical history,
indication and therapy proposal of attending physician,
urgency according to defined classification,
HLA type of patient,
blood group of patient,
weight of patient,
ethnic group of patient,
sex of patient,
age of patient,
known allelic characteristics of patient and/or data of DNA typing, and/or
first treatment or re-treatment,
said classification and/or exclusion criteria being stored on a storage medium and/or processing unit.

The invention also relates to the use of the system for the identification of at least one matching cord blood unit for a patient in need of such a transplant.

### DETAILED DESCRIPTION OF THE INVENTION

In the meaning of the invention, a system describes a set of individual technical components which are related to each other and interact. Advantageously, a system may comprise programs and data processing equipment as well as elements such as transport containers, UCB preparations.

In the meaning of the invention, processing units preferably describe input devices by means of which data or information is entered and stored preferably in digital form. The processing units preferably comprise computers, medical systems, storage devices and/or special processors suitable for input and storage. In a preferred embodiment the processing units can be present separately and/or in various forms of hardware, software and/or firmware. Thus, it can be advantageous if medical systems, such as analyzers, automatically transfer the analyzed data into the system and require no manual input to this end.

In the meaning of the invention the preferred embodiment apply to the method and to the system.

In the meaning of the invention the term “recipient” can also refer to a “patient”.

The teaching of the invention also represents a combination invention in which the above-mentioned elements cooperate to provide a system or method for the allocation and selection of a biological transplant, wherein a complex HLA typing analyses is carried out and the transplants are classified according to this analysis. The effective cooperation of the system or method components generates a synergistic effect which is characterized in that a single system or method is available, so that all operations can be monitored and controlled by the method or system both in a central and decentralized manner. All institutions involved in transplantation, comprising hospitals, UCB banks, or physicians, can gain access to the method or system and monitor the progress of transplantation.

The method according to the invention compares the incoming patient data with the data of registered cord blood units using a multi-level compatibility matrix and varying classification criteria. Advantageously, comparison is fully automatic, and an attending physician can advantageously gain online access to the data. Therefore, the coordinator is not needed necessarily. Advantageously, a physician can be automatically provided with proposed solutions as to which single preparation (single transplant) or which intermatching preparations (multi-transplant) are possible for transplantation. In this way, it is possible to fundamentally change and substantially improve the actual advantage of ready-to-use stored UCB preparations compared to lengthy comparative searches performed by coordinators. The system is suitable for all biological, biochemical or chemical materials subject to time-critical allocation in transplantations or other (medical) applications.

Characteristic empirical values of the UCB preparations are input via processing units such as computers. It may also be advantageous to automatically analyze a preparation using one or more analytical devices and automatically transfer examined values into a processing unit. For example, UCB preparations can be examined and characterized rapidly and efficiently in laboratory lines which represent a kind of serial arrangement of various analytical devices. The analyzed values are automatically entered into the system and thus rapidly available. Advantageously, the values specific and characteristic for a UCB preparation, are stored on a storage medium. In the meaning of the invention the storage medium, or data memory, is used for storing data or information. Advantageously, the data can be supplemented with additional data at any time and are preferably in digital form. It may be preferred that the storage medium is a mass-storage device preferably having magnetic recording technology or semiconductor memory technology. In the meaning of the invention, a mass-storage device represents a storage medium which stores large amounts of data or information preferably for a prolonged period of time. Advantageously, a mass-storage device with magnetic recording technology can be used, which device writes binary data on the surface of a rotating ferromagnetic disk. In the meaning of the invention, semiconductor memories are data memories consisting of a semiconductor wherein integrated circuits are implemented by means of semiconductor technology. The data are preferably stored in the form of binary electronic switching states in the integrated circuits. This allows permanent and safe storage of the data.

Likewise, the data characterizing the recipient is entered into the system by means of processing units and stored on a storage medium. A recipient or potential recipient in the meaning of the invention is an individual having undergone an analysis, wherein in particular a predisposition to a disease or a disease has been found which can preferably be treated by means of a biological transplantation therapy. Advantageously, data relating to patients and preparations (e.g. HLA values or weight and cell number) are correlated by information-processing systems and utilized for the evaluation of matches. Advantageously, the data relating to available umbilical cord blood preparations (UCBP) are provided and updated locally by the blood banks. The data relating to the available UCBP inventory are collected e.g. in a repository (database) and provided for searches therein.

The recipients or the clinics responsible for the recipients can precisely define the criteria according to which the search for a match is to proceed. To increase the efficiency and minimize errors, the search parameters used in weighting and automated selection can be stored centrally for attending physicians and hospitals, for example. Thus, the default search parameter sets can be fetched at the beginning of a search and optionally modified by an expert (expert mode). Advantageously, the search for suitable UCBP proceeds automatically but can also be performed step by step or checked by a person skilled in the art.

Based on an evaluation of the search, the UCB preparation can be ordered from the cord blood bank or hospital. Advantageously, the order is placed via the network and can thus proceed over a long distance without requiring contact with the respective bank. To this end, the processing units and/or storage media are equipped with data transmission units known in the art, which enable fast data transfer. Examples include DSL, ISDN or other connections that can be used for communication between processing units. To prepare order processing, interaction with a blood bank can be advantageous to arrange further or missing investigations. Up to now, this has been a manual and time-consuming step. Advantageously, the method or system supports the processes via automated workflow, i.e. a working process that proceeds in a predefined sequence of activities within an organization. The workflow continuously informs about pending orders and the status of individual orders, thereby improving the quality of the results and making the processes per se more efficient and rapid. When tracking the delivered and transplanted preparations, the system is able to gather information required in medical and pharmacological terms.

When inputting the data, i.e. the experience data, it is preferred that in particular all UCB preparations registered in the system and stored in various UCB banks and collection centers worldwide are acquired as parameters in an advantageously uniform data set (Unit Report). Inter alia, the parameters comprise:
Name and identification of the UCB storage bank
Status of the UCB storage bank with regard to international certifications
Process reliability of the UCB bank according to classification
Contact in the respective bank, including contact data
Identification number of preparation
Medical history of mother, child and family according to anamnesis form of the maternity clinic
Ethnic group of mother, father and/or child
Sex of child
Date of initial storage of preparation
Details of preparation processing
Blood group of preparation
HLA type of preparation
Cell count (TNC) of preparation
Cell count (CD34+) of preparation
Viral status of preparation
Allelic characteristics of preparation and/or
Parameters of molecular diagnostics and analysis

Said data set is preferably being stored on a storage medium and/or processing unit. Advantageously, the parameters or are input into the system and surprisingly allow unambiguous characterization of a umbilical cord blood preparation (UCBP) because, as a result of the entered data or combination of parameters, each preparation is defined by its specific properties or parameters. Advantageously, this is achieved by combined acquisition of the parameters. Quite surprisingly, the combination of parameters results in a particularly good solution to the object of the invention. In the meaning of the invention, a parameter describes a characteristic quantity, i.e. a characterizing property, that is inserted in the system in the form of data. Advantageously, the data comprise operational details (attributes) of patients, hospitals, physicians, donors, blood banks, UCB preparations (laboratory values, physical and informational properties), order and process information and controlling information comprising search/exclusion criteria, thresholds, weighting factors. The parameters of molecular diagnoses and analyses preferably comprise the quantities of biomarkers specific to certain diseases. In this way, the system can provide rapid statements relating to the activities of metabolic pathways which might be detrimental to transplantation.

In addition to information relating to the UCB bank, such as name and identification of the UCB bank, the bank's status with respect to international certifications (e.g. FACT: “Foundation for the Accreditation of Cellular Therapy) is stored, thereby ensuring compliance with defined standards regarding the quality of preparations. Advantageously, a contact person in the respective bank can also be entered together with contact data. For example, a contact can be an attending physician, or a coordinator responsible for maintenance of the database in the bank. Furthermore, a system-standardized identification number (ID) is preferably assigned, which allows unambiguous assignment. Moreover, comprehensive searches for preparations from the UCB bank can be performed. In addition, process reliability details for each cord blood bank are automatically collected by the system and included in the search. Furthermore, data relating to the medical history of mother, child and family are included in the database according to an anamnesis form of the maternity hospital. Advantageously, this allows assessment of the preparations with respect to specific diseases such as hereditary diseases. The ethnicity of mother, father and/or child is beneficial as information because specific genetic variations may be associated with the ethnic background and might therefore complicate a transplantation. Advantageously, parameters such as blood group, HLA type, cell count (TNC: total nuclear cells and CD34+), viral status, are also entered into the database. This comprehensive information allows characterization and identification of preparations and, accordingly, optimum assignment of a recipient. The system or the method can use this data for finding an optimal match.

In the meaning of the invention the database comprising the data or parameters may also be referred to as a central data collection, the content of which is composed of data from different sources. The database not only manages all data of the individual preparations in each of the UCB banks, but also dynamically matches each inserted preparation with all other preparations in the various UCB banks, thereby automatically documenting upon registration of each preparation which combination of preparations can be used for potential subsequent double or multiple transplantation (multi-cord).

The first classification criterion for such a multi-cord match between registered preparations is the HLA match, but it may also be preferred that the first classification criterion is the blood group or the TNC count. Matching is preferably present in at least four out of six HLA features, and those preparations having the most HLA matches are at the top in the order of suitability as multi-cord. The system is able to calculate incompatibilities and provide a clear representation thereof. Certain characteristics increasing the risk of rejection can be identified. Early recognition of such a risk, i.e. prior to transplantation, can avoid incompatible preparations during selection. If no alternative preparations are available, early onset of therapy can reduce or even completely suppress a rejection response. Surprisingly, owing to the classification criteria, the system is able to use only fully compatible UCB preparations for transplantation.

In the meaning of the invention, classification describes a defined order of elements. Classification of the elements can be related to their properties, e.g. the parameters or attributes (for example, UCB preparations). In the meaning of the invention the classification criteria describe the way in which the classification is created (for example, all UCB preparations according to their TNC size from the largest down to the smallest preparation). Advantageously, it is possible to apply filtering criteria to a classification, which means that, for example, only those preparations having a defined TNC size are included in a search. It is particularly advantageous that, in the event of relatively large amounts of data, these classifications can be used as index to perform e.g. efficient searches (also as a combination using a number of criteria).

In a preferred fashion the inquiring hospital performs a patient search wherein the determination of patient-compatible preparations comprises the following classification and/or exclusion criteria:
Name and ID of clinic or transplantation center
Names of coordinator and attending physician, including contact data
Status of clinic with regard to international certifications (e.g. FACT)
Average number of UCB transplantations in the inquiring clinic during the last three years
Name of patient, insurance number and other accounting information
Patient's medical history
Indication and therapy proposal of attending physician
Urgency according to defined classification
HLA type of patient
Blood group of patient
Weight of patient
Ethnic group of patient
Sex of patient
Age of patient
Known allelic characteristics of patient and/or data of DNA typing
First treatment or re-treatment
said classification and/or exclusion criteria being stored on a storage medium and/or processing unit.

It is also preferred to use and individually weight the following classification criteria and/or exclusion criteria:
Preparations having a CD34+ cell count above 10% of the TNC count
Exclusion of preparations wherein less than 75% of the CD34+ cells survived and/or were activated in a CA (colony assay)
Blood group identity
Ethnic identity
Gender
Age of preparation
Accreditation standard
Ranking of the UCB bank

The preferred embodiment can ensure optimum quality of the preparations, thereby allowing successful transplantation. Advantageously, preparations having a CD34+ cell count above 10% of the TNC count are weighted differently to this end. Preparations wherein less than 75% of the CD34+ cells survived and/or were activated in the CA (Colony assay) are excluded so as to ensure a high number of hematopoietic stem cells. Similarly, this applies to CD133+ cells. Other criteria such as blood group identity, ethnic identity and gender can further circumscribe the selection of a preparation. Furthermore, old preparations can be excluded by determining the age of the preparation, so that only those preparations not having exceeded a defined age are advantageously used for transplantation, thereby ensuring surprisingly high quality. The accreditation standard ranking of the UCB bank can also be considered for selection. In this way, banks having e.g. little experience in storage or transplantation of umbilical cord blood can be excluded. The combination of classification and/or exclusion criteria allows qualitative characterization of the preparations, thereby reducing rejection of the preparations in transplantation and ensuring that a patient receives the “best”, i.e. the best tolerated, preparation.

In allotransplantation, the transplanted tissue is not derived from the recipient but from a donor of the same biological species. To avoid serious or fatal rejection of foreign tissue, preferably complete matching of features recognized by the immune system with the host tissue is required for successful allogeneic transplantation. Cord blood unit preparations and recipient are characterized in detail by high-resolution analyses, and the method or system can detect and avoid incompatibilities not detectable by standard methods (e.g. blood analysis). On the basis of preset parameters, it is possible by means of the preferred embodiment to perform an easy, rapid and advantageously automated search for a suitable, i.e. matching, preparation, so that—quite surprisingly—the risk of rejection is minimized and successful transplantation is not obstructed in any way.

In another preferred embodiment, an automatic and full-range selection of single-cord or multi-cord transplants is performed, wherein appropriate preparations are proposed to the attending physician and/or the coordinator, which preparations match in their parameters and do not generate any rejection responses. Advantageously, preparations matching each other and the patients are appropriately displayed so as to substantially facilitate and speed up the selection. The attending physician can therefore receive a representation of the two choices and come to an own judgment as to whether a multi-cord or single-cord transplantation should be performed. Surprisingly, automatic selection can avoid errors, and single-cord or multi-cord transplants can be presented to the attending physician. Advantageously, the presentation proceeds in a clear and concise manner, thereby facilitating the selection of preparations by the physician.

Thus, automatic and complete proposals of solutions for single-cord or multi-cord transplants can be developed. Advantageously, coordinator and physician can focus on the suitability of various well-defined and well-documented proposals of solutions. Search parameters and results are presented in a clear and concise manner, thereby substantially facilitating the selection. Also, the parameters forming the basis of the search are variable and can be adapted to the patient and/or the desired preparation. This is a great improvement over the current situation in which coordinators are obliged to assess potential transplants at a very early stage according to various criteria. At present, this leads to unsatisfactory results and is exceedingly time-consuming and labor-intensive. Thus, the preferred embodiment allows searching and ordering one or more suitable preparations within a short period of time.

Although the invention has been described with respect to specific embodiments and examples, it should be appreciated that other embodiments utilizing the concept of the present invention are possible without departing from the scope of the invention. The present invention is defined by the claimed elements, and any and all modifications, variations, or equivalents that fall within the true spirit and scope of the underlying principles.

### EXAMPLES AND FIGURES

FIG. 1 Overview of the preferred method

FIG. 2 Serological equivalents structure

FIGS. 3 and 4 Finding serological equivalents

FIG. 5 Main search vector structure

FIG. 6 Molecular to serological conversion

FIG. 7 Converting different resolutions

FIG. 8 Filtering and grouping

FIG. 9 Sorting the result

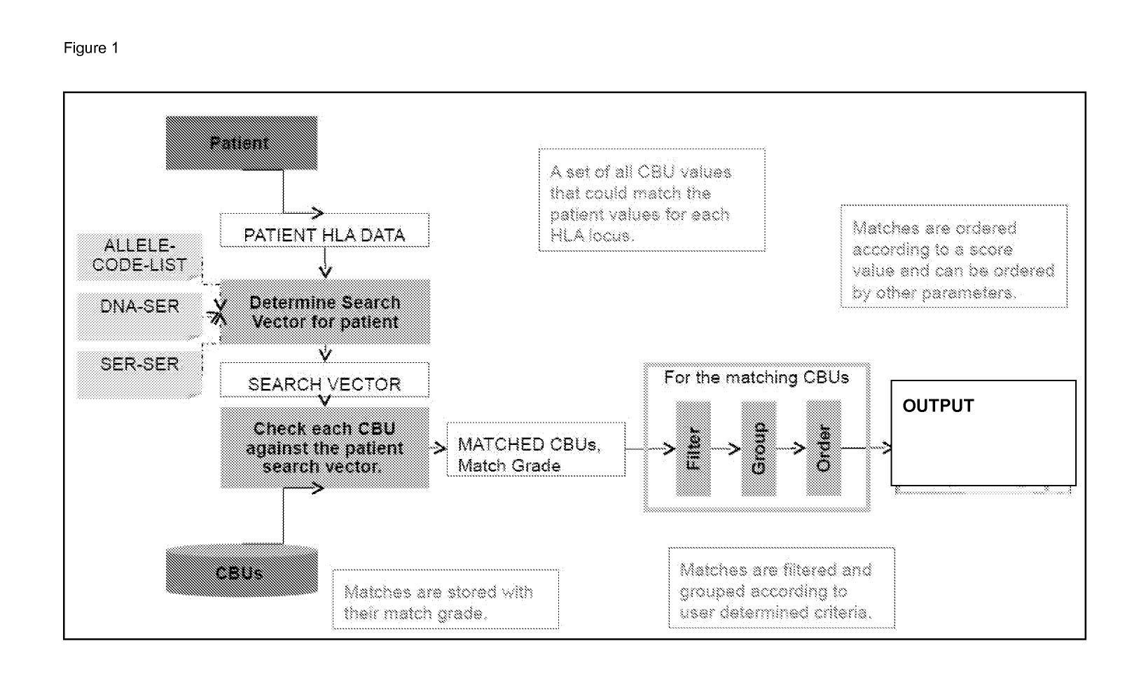

The method or system compares a patient's HLA data and finds CBUs that match these. Matchings are ranked according to how closely the patient HLA data matches to the data in each CBU. To perform this (see FIG. 1) the method first determines a search vector for the patient HLA data. The search vector contains all possible matches to a patient's HLA values together with a ranking that determines where matching CBUs are placed in the results list.

To determine the elements in the search vector a number of mapping tables are used:
SER-SER—Maps serological types to equivalent serological types.
DNA-SER—Maps molecular types to the equivalent serological types.
ALLELE-CODE-LIST resolves the codes used in medium resolution molecular types

In SER-SER the serologic loci that are mapped to C, DRB1 and DQB1 are Cw, DR and DQ. A preferred prerequisite for the matching is that molecular patient and CBU values have been converted to the new (2010) nomenclature. This mapping is performed using the NOMENCLATUR_{—}2009 [sic] tables. Using the search vector the method checks each CBU unit to determine if it contains one of the patient's search vector values. If so the method returns the matched CBUs together with the previously determined ranking in the search vector. The matched CBUs are then:
Filtered according to a set of user defined criteria.
Grouped according to a set of user defined grouping criteria. Typically the grouping will be done according to how many matches have been made. Matches are categorized as either ACTUAL or POTENTIAL matches. ACTUAL matches are when the patient and CBU have both been molecularly typed and the molecular codes match. POTENTIAL matches exist when the patient and CBU values are not both high resolution (either molecular or serologic) and match or a conversion to another resolution yields a match.
Ordered within each group according to the overall ranking of the matches as well as other user determined factors, such as the TNC

Finally the filter, grouped and ordered list of matching CBUs is returned and displayed by the preferred method or system.

Patient and CBUs contain several values for each HLA locus considered by the method. However, the method or system preferably considers the following HLA-loci: A, B and DRB1. Each value is represented by a code. Different code structures are used depending on whether the HLA locus has been molecularly or serological typed and also dependent on the “resolution” of the typing. These are shown in the following table

TABLE 1

| Type | Resolution | Description | Examples |
|---|---|---|---|
| Molecular | High (Hi) | The HLA locus, allele | A*66:03 |
| | | type and allele sub-type | A*68:01:05 |
| | | are fully specified | |
| Molecular | Medium | The HLA locus and | A*:68:AFSS |
| | (Med) | allele type are specifed. | matches |
| | | The allele HLA sub- | A*68:09, A*68:39 |
| | | type specifies a range | |
| | | of possible values by | |
| | | using a code. The | |
| | | codes are specified in | |
| | | the file | |
| | | ALLELE_CODE_LIST | |
| Molecular | Low (Lo) | The HLA locus and the | B*51:XX |
| | | allele type are | |
| | | specified. The HLA | |
| | | allele sub-type is | |
| | | unspecified (i.e. has | |
| | | code XX) | |
| Serological | Broad | Serological specificity | A28 |
| | | that is poor or broad | |
| | | relative to other | |
| | | specificities and maybe | |
| | | is defined as 2 or more | |
| | | split antigens. Broad | |
| | | serological types have, | |
| | | by definition, one of | |
| | | more splits or | |
| | | associates. | |
| Serological | Split | An antigen that has a | A68, A69, |
| | | more refined or specific | B64, B51 |
| | | cell surface reaction | |
| | | relative to a broad | |
| | | antigen. | |
| Serological | Associated | | B5102, A203 |
| Serlogical | Antigen | Specific serological | |
| | | types that do NOT have | |
| | | splits or associates. | |

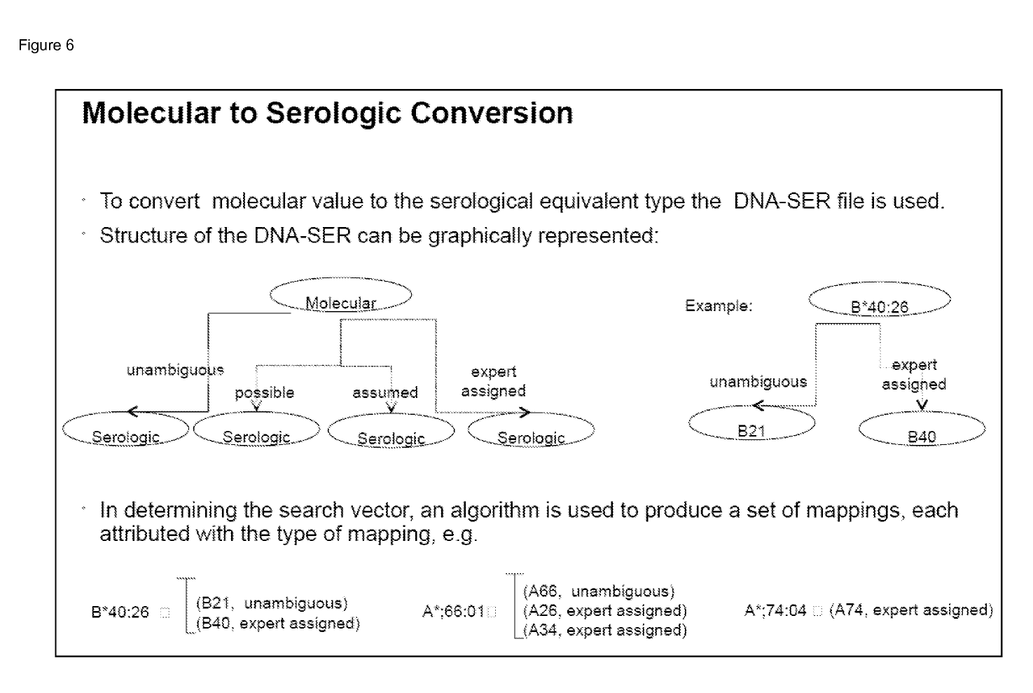

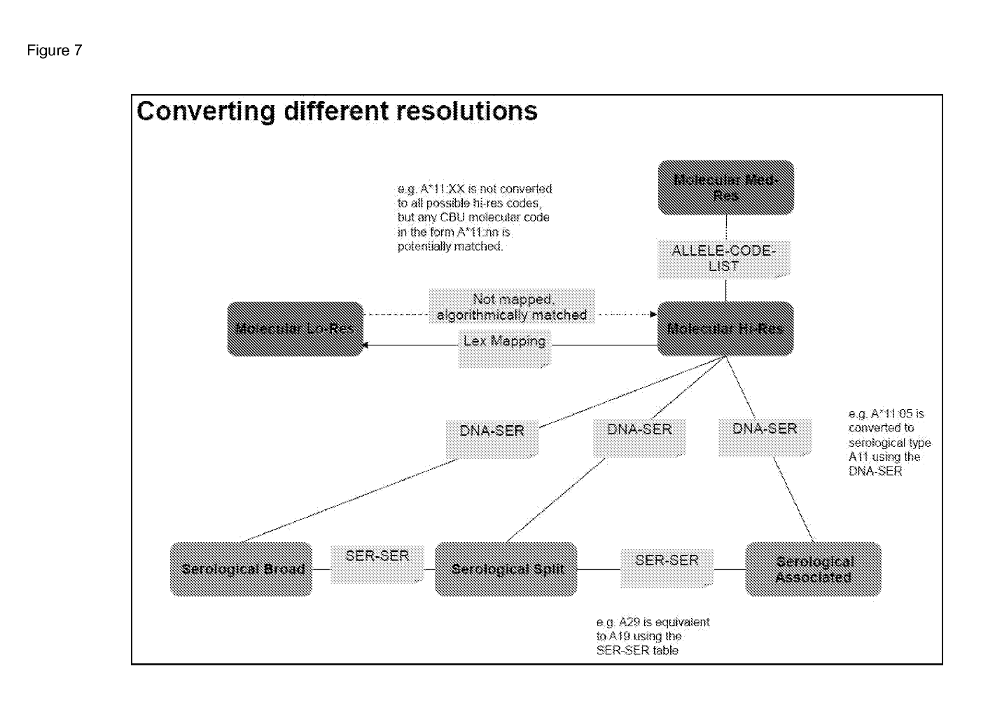

HLA Loci are either coded as molecular or serological types. It is assumed that the molecular codes are in the new format as specified by the WHO Nomenclature Committee for Factors of the HLA System and effective April 2010. Molecular patient and CBU values using the nomenclature will be converted to the new one using the conversion table NOMENCLATURE_{—}2009. The molecular codes are preferably in three categories: High resolution (in which the allele is directly specified), medium resolution (in which a range of possible values is given) and low resolution (in which only the HLA locus and allele type is specified). Serological codes have no clearly defined structure, but can be classified into different “resolution” types: Antigen, Broad, Split and Associate. The molecular codes can be translated or converted into serological codes and vice versa (see FIG. 6). In general, different resolutions can be converted (see FIG. 7).

### High Resolution Molecular Codes.

Molecular codes are best illustrated with an example:

TABLE 2
A*02:01:01:02L =

| | | Relevant for |
|---|---|---|
| Field | Meaning | Matching |
| A | HLA Locus | ✓ |
| 02 | Allele Type. This can be more than two digits. | ✓ |
| 01 | Allele Sub-Type. This can be more than two | ✓ |
| | digits. | |
| 01 | Alleles that differ only by synonymous | |
| | nucleotide substitutions (also called silent or | |
| | non-coding substitutions). This can be more | |
| | than two digits. Optional. | |
| 02 | Alleles that only differ by sequence | |
| | polymorphisms in the introns or in the 5′ or 3′ | |
| | untranslated regions that flank the exons and | |
| | introns are distinguished by the use of the | |
| | seventh and eight digits. Optional. | |
| L | Suffix (optional). | |
| | ‘Null’ alleles have been given the suffix ‘N’ | ✓ |
| | Those alleles which have been shown to be | |
| | alternatively expressed which may have the | |
| | suffix ‘L’, ‘S’, ‘C’, ‘A’ or ‘Q’. | |

Those fields that are preferably used in the method are shown in the third column.

### Medium Resolution Molecular Codes

Medium resolution codes refer to a range of possible values, for instance: B*51:AB, A*03:ABPT and B*22:ATKR.

The two to four digit codes determine the possible values according to the ALLELE_CODE_LIST. For instance:
AB expands to 01, 02.
ABPT expands to 06, 51
ATKR expands to 01, 07, 17, 19, 21, 24

In addition the codes can determine possible sets of allele type and sub.type. This can occur in cases in which the possible values associated with the code either cross serologic groups or include null alleles. For instance:
B*35:FERP expands to B*35:34 and B*53:01
B*37:AWZT expands to B*37:02 and B*37:03N

### Low Resolution Molecular Codes.

Low resolution molecular codes only specify the HLA Locus and the allele type. An “XX” is used to indicate this, e.g. A*03:XX and B*51:XX

### Serological Codes

Serological codes are simply named with a letter (that usually—but not necessarily—corresponds to the HLA locus) and a number representing the serological type, e.g. B15, B52 and A2403.

No structure is present in the name. If the code represents a direct antigen or a broad, split or associated antigen can only be inferred from the SER-SER table.

### Combination of HLA Values

HLA values of cord blood units and patients can be mixed in resolution and type. This means the HLA data of a patient or CBU can be molecular and/or serologic. One value pair of one locus has to be either serologic or molecular for both values but may be in different resolutions. For one locus there can also be two value pairs, the values are either provided molecular or serologic or both. If serologic and molecular values are provided for one locus the molecular values have to be used for matching.

### EXAMPLE 1.

TABLE 3
Cord blood unit with serologic and molecular values for different loci:

| | | |
|---|---|---|
| A | SER | A2 |
| A | SER | A11 |
| B | DNA | 08:BMNN |
| B | DNA | 44:BNGF |
| DRB1 | DNA | 03:01 |
| DRB1 | DNA | 15:XX |

### EXAMPLE 2.

TABLE 4
Cord blood unit with serologic and molecular values for the same loci:

| | | |
|---|---|---|
| A | DNA | 02:01 |
| A | DNA | 11:01 |
| A | SER | A2 |
| A | SER | A11 |
| B | DNA | 08:BMNN |
| B | DNA | 44:BNGF |
| DRB1 | DNA | 03:01 |
| DRB1 | DNA | 15:XX |

### Validation of HLA Values

For molecular high resolution values the value is checked against the full code and against the matching relevant part of the code in table DNA-SER. For molecular medium and low resolution values the values are checked in a first step for the allele type (e.g. A*01:) against table DNA-SER. For generic molecular medium resolution values it is checked in a second step if the code is listed in the ALLELE-CODE-LIST, e.g.: A*01:AA->AA is in mapping table. For allele specific molecular medium resolution values it is checked in a second step if the code is listed in the ALLELE-CODE-LIST and if the value is valid for this code, e.g. B*13:BM->BM is in mapping table and there is at least one code with B*13. For molecular low resolution values it is checked in a second step if the Allele sub type is “XX”. For serologic values it is checked if the value is listed in table DNA-SER. The value DR5 is the only known serologic value missing in this table and has to be checked additionally. DNA-SER has mapping entries for null Alleles, which do not have serologic expressions. These are marked as “0”. Therefore “0” is not a valid serologic value, e.g: A*;01:01:01:02N;0; does not declare a mapping. In SER-SER the loci that are equivalent to C, DRB1 and DQB1 are Cw, DR and DQ.

### Search Vectors

The method or system first generates a search vector for each value pair for the loci under consideration. The search vector contains possible values that a CBU could contain that are either actual or potential matches of the patient values. For instance a value

### B*51:02:

could match CBUs that contain the following values:

| | |
|---|---|
| B*51:02 | B51 |
| B*51:XX | B5102 |
| B*51:AB | B5 |
| B*51:BC | . . . and many more |

In addition, each of the possible values is assigned a ranking or weighting that determines (with other factors) where a CBU whose value is in the search table appears in the results list. As such the search vector is created two steps. First the possible CBU values are determined and secondly a ranking is assigned. If in determining the search vector an exception arises (such as a molecular type is encountered that is not in the DNA-SER table) then the value is rejected and this rejection logged.

### Determining the Search Vector Values

The search vector values are determined from the patient values using a number of different techniques depending the type (molecular/serological) and resolution of the patient values. For each patient value a number of possible CBU values are generated effectively for each resolution and these placed in the search vector.

TABLE 5
Determining Search Vector Values for molecular
typed patient or cord blood unit:

| | Search Vector (SV) | | | |
|---|---|---|---|---|
| Patient | Molecular | | | |
| Resolution | High | Medium | Low | Serological |
| High | Place given | Determine | Determine low | Determine |
| | code (high | medium | resolution | serological |
| | resolution) | resolution | code for given | codes for |
| | directly in | codes for | code (high | given code |
| | the SV | given code | resolution) | (high |
| | | (high | | resolution) |
| | | resolution) | | Determine |
| | | | | serological |
| | | | | parent and |
| | | | | child |
| | | | | equivalents |
| | | | | for |
| | | | | determined |
| | | | | serological |
| | | | | codes |
| Medium | Determine | Place given | Determine low | Determine |
| | high | code | resolution | serological |
| | resolution | (medium | code for | codes for |
| | codes for | resolution) | determined | determined |
| | given code | directly in the | high | high |
| | (medium | SV | resolution | resolution |
| | resolution) | Determine | codes | codes |
| | | medium | | Determine |
| | | resolution | | serological |
| | | codes for | | parent and |
| | | determined | | child |
| | | high | | equivalents |
| | | resolution | | for |
| | | codes | | determined |
| Low | Determine | Determine | Place given | serological |
| | high | medium | code (low | codes |
| | resolution | resolution | resolution) | |
| | codes for | codes for | directly in the | |
| | given code | determined | SV | |
| | (low | high | | |
| | resolution) | resolution | | |
| | | codes | | |

TABLE 6
Determining Search Vector Values for serological
typed patient or cord blood unit:

| | Search Vector (SV) | | | |
|---|---|---|---|---|
| Patient | Molecular | | | |
| Resolution | High | Medium | Low | Serological |
| Broad | Determine high | Determine medium | Determine low | Place given code |
| Split | resolution | resolution | resolution | (serological) |
| Associates | codes for | codes for | code for | directly in the |
| Antigen | given code | determined | determined | SV |
| | (serological) | high | high | Determine |
| | Determine high | resolution | resolution | serological |
| | resolution | codes | codes | parent and |
| | codes for | | | child |
| | determined | | | equivalents (if |
| | [symbol] | | | [symbol] |

[symbol]

indicates data missing or illegible when filed

To create a search vector for a molecular high resolution code,

(1) the given molecular high resolution code is directly placed in the search vector as actual match,
(2) the molecular medium resolution codes for the given molecular high resolution code are determined and placed these in the search vector as potential match,
(3) the molecular low resolution codes for the given molecular high resolution code are determined and placed in the search vector as potential match,
(4) the serological codes for the given molecular high resolution code are determined and placed in the search vector as potential match,
(5) the serological parent and child equivalents for the determined serological codes are determined and, if these exist, placed these in the search vector as potential match,
(6) the rank for the placed codes is determined.

### Use Cases

Only several examples of codes are presented (not all codes!). For medium resolution codes both examples are presented: generic and allele specific.

Use Case 1.1: given molecular high resolution code A*01:01:01:01

| Search Vector | Code | Match | Rank |
|---|---|---|---|
| given code | A*01:01 | actual | |

Use Case 1.2: given molecular high resolution code A*01:01:01:01N

| Search Vector | Code | Match | Rank |
|---|---|---|---|
| given code | A*01:01N | actual | |

Use Case 2: given molecular high resolution code A*24:02

| Search Vector | Code | Match | Rank |
|---|---|---|---|
| molecular medium resolution codes | A*24:AA (<- 02) | potential | |
| for the given molecular high | A*24:AMG (<- | | |
| resolution code | 24:02) | | |

Use Case 3: given molecular high resolution code A*01:01:01:01N

| Search Vector | Code | Match | Rank |
|---|---|---|---|
| molecular low resolution code | A*01:XX | potential | |
| for the given molecular high resolution | | | |
| code | | | |

Use Case 4.1: given molecular high resolution code A*01:01:01:01

| Search Vector | Code | Match | Rank |
|---|---|---|---|
| serological codes | A1 (unambiguous) | potential | |
| for the given molecular high | | | |
| resolution code | | | |

Use Case 4.2: given molecular high resolution code B*13:04

| Search Vector | Code | Match | Rank |
|---|---|---|---|
| serological codes | B15 (possible) | potential | |
| for the given molecular high | B13 (expert | | |
| resolution code | assigned | | |
| | exceptions) | | |

Use Case 5: given molecular high resolution code B*39:05:01

| Search Vector | Code | Match | Rank |
|---|---|---|---|
| serological parent equivalents | B16 (<-B39) | potential | |
| for the determined serological code | | | |
| serological child equivalents | B3901 (<- B39) | potential | |
| for the determined serological code | | | |

### To Create a Search Vector for a Molecular Medium Resolution Code,

(1) the given molecular medium resolution code is directly place in the search vector as potential match,
(2) the molecular high resolution codes for the given molecular medium resolution code are determined and placed in the search vector as potential match,
(3) the molecular medium resolution codes for the determined molecular high resolution molecular codes are determined and placed in the search vector as potential match,
(4) the molecular low resolution codes for the determined molecular high resolution codes are determined and placed in the search vector as potential match,
(5) the serological codes for the determined molecular high resolution codes are determined and placed in the search vector as potential match,
(6) the serological parent and child equivalents for the determined serological codes are determined and, if these exist, placed in the search vector as potential match,
(7) the placed codes are ranked.

### Use Cases:

Only several examples of codes are presented (not all codes!). For medium resolution codes both examples are presented: generic and allele specific.

Use Case 1: given molecular medium resolution code A*01:AA

| Search Vector | Code | Match | Rank |
|---|---|---|---|
| given code | A*01:AA | potential | |

Use Case 2:1: given molecular medium resolution code A*24:AA; AA is generic code—Jan. 2, 2003/05

| Search Vector | Code | Match | Rank |
|---|---|---|---|
| molecular high resolution codes | A*24:01 | potential | |
| for the given molecular medium resolution | A*24:02 | | |
| code | A*24:03 | | |

Use Case 2:2: given molecular medium resolution code DRB1*13:BM BM is allele specific code—13:05/13:06/13:07/13:09/14:05/14:08

| Search Vector | Code | Match | Rank |
|---|---|---|---|
| molecular high resolution codes for the | DRB1*13:05 | potential | |
| given molecular medium resolution | | | |
| code | | | |

Validate high resolution codes (DRB1*14:05 is not valid, because the allele type is different)

Use Case 3: given molecular medium resolution code A*24:AMG

| Search Vector | Code | Match | Rank |
|---|---|---|---|
| molecular medium resolution | A*24:AA (<- 24:02) | potential | |
| codes for the determined | | | |
| molecular high resolution code | | | |

Use Case 4: given molecular medium resolution code A*01:AA

| Search Vector | Code | Match | Rank |
|---|---|---|---|
| molecular low resolution code | A*01:XX (<- 01:01) | potential | |
| for the determined molecular | | | |
| high resolution code | | | |

Use Case 5: given molecular medium resolution code A*01:AR

| Search Vector | Code | Match | Rank |
|---|---|---|---|
| serological codes for the | A1 (<- A*01:01:02) | potential | |
| determined molecular high | | | |
| resolution code | | | |

Use Case 6: given molecular medium resolution code B*39:AA (->B*39:05->B39)

| Search Vector | Code | Match | Rank |
|---|---|---|---|
| serological parent equivalents | B16 (<-B39) | potential | |
| for the determined serological code | | | |
| serological child equivalents | B3901 (<- B39) | potential | |
| for the determined serological code | | | |

### To Create a Search Vector for a Molecular Low Resolution Code,

(1) the given molecular low resolution code is directly placed in the search vector as potential match,
(2) the molecular high resolution codes for the given molecular low resolution code are determined and placed in the search vector as potential match,
(3) the molecular medium resolution codes for the determined molecular high resolution codes are determined and placed in the search vector as potential match,
(4) the serological codes for the determined molecular high resolution codes are determined and placed in the search vector as potential match,
(5) the serological parent and children equivalents for the determined serological codes are determined and, if these exist, placed in the search vector as potential match,
(6) the placed codes are ranked.

Use Cases:

Only several examples of codes are presented (not all codes!). For medium resolution codes both examples are presented: generic and allele specific.

Use Case 1: given molecular low resolution code A*01:XX

| Search Vector | Code | Match | Rank |
|---|---|---|---|
| given code | A*01:XX | potential | |

Use Case 2: given molecular low resolution code A*24:XX (->A*24:02:01:01)

| Search Vector | Code | Match | Rank |
|---|---|---|---|
| molecular high resolution codes for the | A*24:02 | potential | |
| given molecular low resolution code | | | |

Use Case 3: given molecular low resolution code A*24:XX (->A*24:02:01:01, A*24:03:01)

| Search Vector | Code | Match | Rank |
|---|---|---|---|
| molecular medium resolution | A*24:AA (<- 24:03) | potential | |
| codes for the determined | A*24:AMG (<- | | |
| molecular high resolution codes | 24:02) | | |

Use Case 4: given molecular low resolution code A*01:XX

| Search Vector | Code | Match | Rank |
|---|---|---|---|
| serological codes for the | A1 (<- A*01:01:02) | potential | |
| determined molecular high | | | |
| resolution code | | | |

Use Case 5: given molecular medium resolution code B*39:XX (->B*39:05->B39)

| Search Vector | Code | Match | Rank |
|---|---|---|---|
| serological parent equivalents | B16 (<-B39) | potential | |
| for the determined serological code | | | |
| serological child equivalents | B3901 (<- B39) | potential | |
| for the determined serological code | | | |

### To Create a Search Vector for a Serological Code,

(1) the given serological code is directly placed in the search vector as potential match,
(2) the serological parent and child equivalents for the given serological codes are determined and, if these exist, placed in the search vector as potential match,
(3) the high resolution codes for the given serological code and for the determined serological child equivalent codes are determined, if these exist and placed in the search vector as potential match,
(4) the medium resolution codes for the determined high resolution molecular codes are determined and placed in the search vector as potential match,
(5) the low resolution codes for the determined high resolution molecular codes are determined and placed in the search vector as potential match,
6) the placed codes are ranked.

### Use Cases

Only several examples of codes are presented (not all codes!). For medium resolution codes both examples are presented: generic and allele specific.

Use case 1: given serological broad code (B16)

| Search Vector | Code | Match | Rank |
|---|---|---|---|
| given code | B16 | potential | |
| serological parent equivalents | — | — | — |
| serological child equivalents | B38 (split) | potential | |
| | B39 (split) | | |
| | B3901 (associates) | | |
| | B3902 (associates) | | |
| high resolution molecular | B*38:03 | potential | |
| codes for given code | | | |
| high resolution molecular codes | B*38:04 (<- B38) | potential | |
| for the determined child | B*39:01 (<- B3901) | | |
| equivalents | B*39:02 (<- B3902) | | |
| medium resolution molecular | B*39:AA (<- 01/02) | potential | |
| codes for the determined high | B*39:GY (<- 39:01) | | |
| resolution codes | | | |
| low resolution molecular codes | B*38:XX | potential | |
| for the determined high | B*39:XX | | |
| resolution codes | | | |

Use case 2: given serological split code (B39)

| Search Vector | Code | Match | Rank |
|---|---|---|---|
| given code | B39 | potential | |
| serological parent equivalents | B16 | potential | |
| serological child equivalents | B3901 | potential | |
| | B3902 | | |
| high resolution molecular codes | B*39:03 | potential | |
| for given code | | | |
| high resolution molecular codes | B*39:01 (<- B3901) | potential | |
| for the determined child | B*39:02 (<- B3902) | | |
| equivalents | | | |
| medium resolution molecular | B*39:AA (<- 01/02) | potential | |
| codes for the determined high | B*39:GY (<- 39:01) | | |
| resolution codes | | | |
| low resolution molecular codes | B*39:XX | potential | |
| for the determined high | | | |
| resolution codes | | | |

Use case 3: given serological associates code (B3901)

| Search Vector | Code | Match | Rank |
|---|---|---|---|
| given code | B3901 | potential | |
| serological parent equivalents | B16 (broad) | potential | |
| | B39 (split) | | |
| serological child equivalents | — | — | — |
| high resolution molecular codes | B*39:01 | potential | |
| for given code | | | |
| high resolution molecular codes | — | — | — |
| for the determined child | | | |
| equivalents | | | |
| medium resolution molecular | B*39:AA (<- 01) | potential | |
| codes for the determined high | B*39:GY (<- 39:01) | | |
| resolution codes | | | |
| low resolution molecular | B*39:XX | potential | |
| codes for the determined high | | | |
| resolution codes | | | |

Use case 4: given serological antigen code (B8)

| Search Vector | Code | Match | Rank |
|---|---|---|---|
| given code | B8 | potential | |
| serological parent equivalents | — | — | — |
| serological child equivalents | — | — | — |
| high resolution molecular codes | B*08:01 | potential | |
| for given code | | | |
| high resolution molecular codes | — | — | — |
| for the determined child equivalents | | | |
| medium resolution molecular codes | B*08:AA (01) | potential | |
| for the determined high | B*08:BBX (<- | | |
| resolution codes | 08:01) | | |
| low resolution molecular codes | B*08:XX | potential | |
| for the determined high | | | |
| resolution codes | | | |

### Determine Medium Resolution Codes for High Resolution Codes

To determine molecular medium resolution codes for molecular high resolution codes the mapping table ALLELE-CODE-LIST is used. Using the ALLELE-CODE-LIST all possible codes that can represent the high resolution molecular value or values are determined. This is the inverse to what is typically done with the ALLELE-CODE-LIST. Usually a code is used to determine the sub-alleles in a molecular code, e.g. .B*35:ETTR could refer to B*35:83, B*35:02 or B*35:06. However, the method or system used here allows the determination determines of codes that could fit to the high resolution molecular code. For instance, B*35:99 could be potentially matched with:

| | | |
|---|---|---|
| B*35:FSWD | B*35:BKDM | B*35:CBAS |
| B*35:DCRT | B*35:FSPW | B*35:CBAR |
| B*35:CPNK | B*35:FMXP | B*35:FYXS |
| B*35:BTHW | B*35:FSPV | B*35:CBAP |
| B*35:FFTM | B*35:DMXP | B*35:FXNE |
| B*35:CGBW | B*35:FWCH | B*35:FXUE |
| B*35:EDHJ | B*35:EDJA | B*35:FWKT |
| B*35:DUEX | B*35:CCHB | B*35:CBAK |
| B*35:CKMD | B*35:BZRN | B*35:FWZP |
| B*35:CBAT | B*35:CJWM | B*35:FYYH |
| B*35:FYKN | B*35:BMPA | B*35:BFTP |

If there is more than one high resolution value, e.g. because of serological equivalents, each high-resolution code maps to medium resolution codes and is then entered into the search vector. Previously found codes are not duplicated. So, for instance:
B*14:03 maps to codes B*14:AC, B*14:BC, B*14:CD, B*14:CE etc. and these are added to the search vector.
B*14:04 maps to codes B*14:AD, B*14:BD, B*14:DF etc. and these are added to the search vector. It also maps to B*14:CD, but this has already been added to the search vector.
B*14:03 also maps to codes such as B*14:BZG (1402/1403/1407N) and B*14:BTXU (i.e. 1402/1404/1407N) etc.
B*14:07N maps to B*14:BPYK, B*14:BPBG etc

### Determine Low Resolution Codes for High Resolution Codes

To determine molecular low resolution codes for a molecular high resolution code the lexical conversion is used. Both high and medium resolution molecular codes can be converted to a low molecular resolution by keeping the HLA locus designator and the allele type and replacing any other fields in the nomenclature to XX, i.e.
L*NN:MM→L*NN:XX

Examples are
B*15:03→B:15:XX
B*15:03:01→B:15:XX
A*32:18→A:32:XX

### Determine Possible High Resolution Codes

To determine molecular high resolution codes for a molecular medium resolution code the mapping table ALLELE-CODE-LIST is used. Medium resolution codes can be converted into potential high-resolution molecular codes by looking up the code on the ALLELE-CODE-LIST and generating all potential high-resolution molecular codes from it. E.g.
B*07:AB→B*07:01, B*07:02
B*27:NFV→B*27:01, B*27:05, B*27:15, B*27:24

The ALLELE-CODE-LIST also contains codes for allele combinations that cross serologic groups and for combinations that contain null alleles. As such these allele specific codes are used for combinations that cannot be represented by generic codes.

Examples are:
DRB1*15:AW→DRB115:01 and DRB1*:16:01—cross serologic group
A*24:AMG→A*24:02 and A*24:09N—because this combination contains a null allele the code is not A*24:BH

When determining high resolution codes for allele specific codes only those high resolution codes that match the given allele type have to be added. For the given example this would mean if DRB1*15:AW is given, only DRB1*15:01 has to be added, since DRB1*16:01 has a different allele type. To determine molecular high resolution codes for a molecular low resolution code the mapping table NOMENCLATURE_{—}2009 is used that contains all valid molecular codes.

### Determine High Resolution Codes for Serological Codes

To determine molecular high resolution codes for serological codes the mapping table DNA-SER is used. Serologic types can be converted to potential molecular types by using the DNA-SER table “in reverse” (normally the DNA-SER table is used to show the serologic types produced by the alleles represented by the molecular code). Examples are;

B41 unambiguously maps to:
B*41:01
B*41:02:01
B*41:02:02
B*41:03:01
B*41:03:02

B41 also has expert assignments to:
B*41:04
B*41:05
B*41:06
B*41:07
B*41:08
B*41:09
B*41:10
B*41:11
B*41:12

The expert assignments (as are possible and assumed assignments) are also placed in the search vector, but with a lower ranking.

### Determine Serological Codes for High Resolution Codes

To determine serological codes for molecular high resolution codes

1. the mapping table DNA-SER is used,
2. the determined serological codes are differentiated by the mapping type (unambiguous, possible, assumed and expert assignments), because this information is important for rank determining

### Determine Serological Parent and Child Equivalents

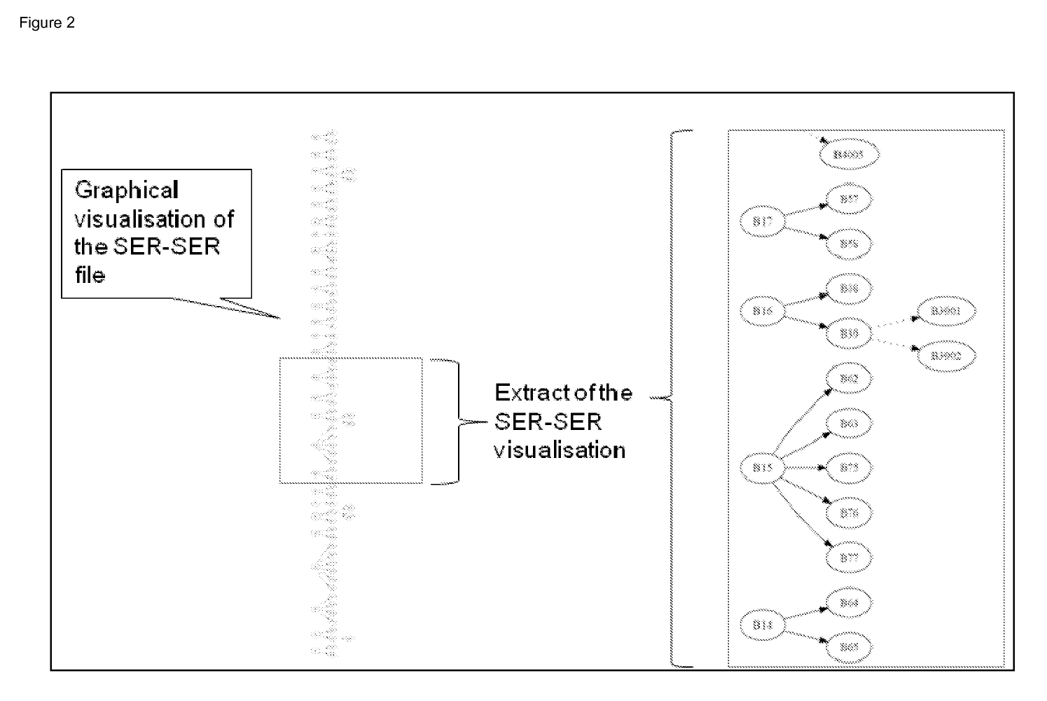

To determine serological parent codes for a serological code the map-ping table SER-SER is used. To determine serological child codes for a serological code the mapping table SER-SER is used. Independent of if the patient values have been entered using serological types or if the molecular codes have been converted to serological types, the preferred method or system determines if the serological type has any equivalents. Equivalents are defined as relationships in the SER-SER table. These have a tree structure as shown in FIG. 2.

Each tree structure has as a root the broad antigen. Under this come as direct children splits and/or associates. Splits can again have associates as children.

### Example Structure:

| | | |
|---|---|---|
| Broad | → Associate | |
| | → Split | |
| | → Split | → Associate |
| | | → Associate |

For instance in FIG. 2 the broad antigen B16 has two splits; B39 and B38. B39 in turn has two associated antigens B3901 and B3902. To find the serological equivalents that should be placed in the search vector, the preferred method or system places the initial serological type first into the search vector (if not already there) and then places the serological types that are higher in the tree into the search vectors. The preferred method or system then finds all the serological types that are lower in the tree and places these in the search vector.

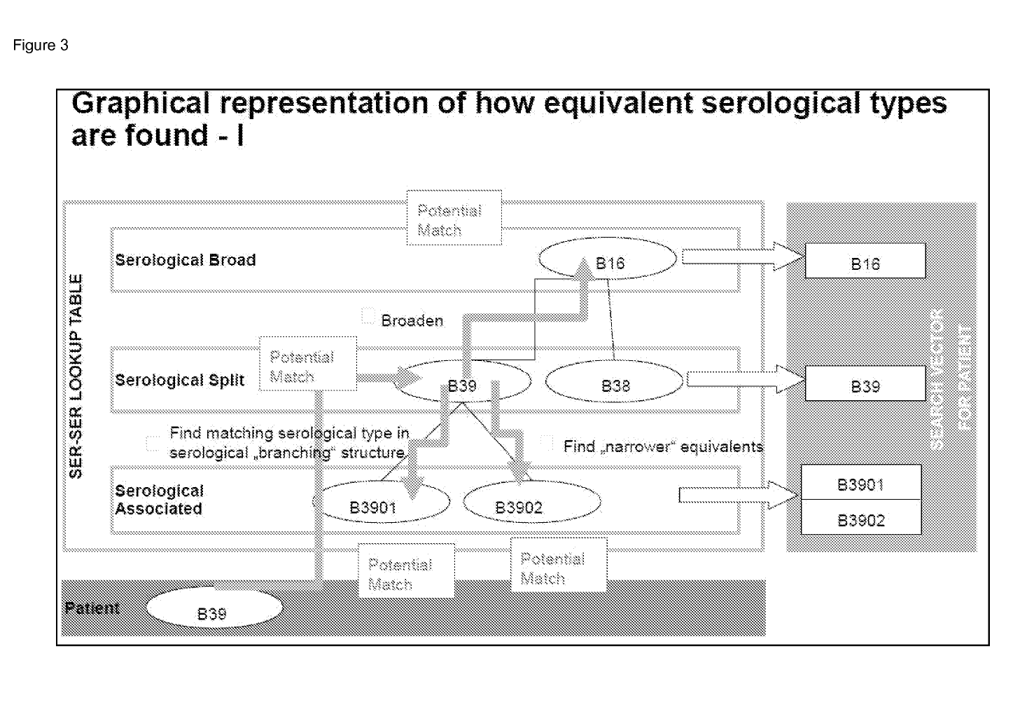

For instance, in FIG. 3, the patient's serological type is B39. Going up the tree toward the root, the preferred method or system finds the serological type B16 and places this into the search vector. Below B39 in the tree are serological types B3901 and B3902. These are also placed in the search vector. The dotted lines indicate the original relationships and are not part of the search vector

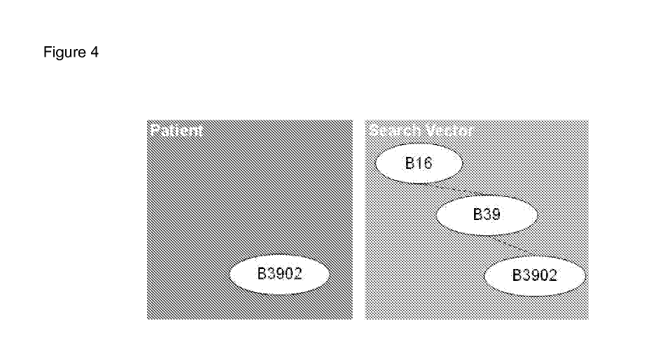

FIG. 4 shows the case when the patient's serological type is an associated antigen. Only the patient's antigen and antigens higher in the tree are added to the search vector, i.e. B3902 plus the split B39 and the broad antigen B16 are added (see FIG. 3).

### Other Matching Factors

### Null Alleles Matching

Null alleles have to be handled as following:

If the locus, allele type and allele sub-type are the same for the patient and CBU, but the patient's allele is a null allele then this is classified as NO MATCH. This is due to the fact that the CBU antigen on the cell surface is not present in the patient and could cause an adverse reaction.

However, if the alleles match between the patient and the CBU, but the CBUs allele is null then this is classified as a MATCH as the CBU antigen is not present on the cell surface and makes causes no reaction in the patient.

### Multi Cord Matching

For Null Alleles Matching in combination with multi cord matching a special processing is necessary. If a patient has a value 01:01 and we have two CBUs:

### 1. CBU1: 01:01N

### 2. CBU2: 01:01

Compared to the patient both CBUs would be a match. When comparing CBU1 and CBU2 for the multi cord matching it would depend on the order of the comparison if this is a match or no match. Since it is due to the fact that the CBU antigen on the cell surface is not present in the patient and could cause an adverse reaction this does not matter between the two CBUs. This means the match between CBU1 and CBU2 is independent of the direction the two CBUs (Use Case 9) are matched.

### Use Cases

### Use Cases for a Singlecord Solution

Patient HLA: molecular (01:01, 01:01N, 01:AA, 01:XX) or serological (1)

Search in all cord blood units (01:01, 01:01N)

| | HLA | | | |
|---|---|---|---|---|
| Use | | | Cord blood | |
| case | Patient | Search Vector* | unit | Match |
| 1. | 01:01 | 01:01 | 01:01 | MATCH |
| 2. | 01:01 | 01:01 | 01:01N | MATCH |
| 3. | 01:01N | 01:01N | 01:01N | MATCH |
| 4. | 01:01N | 01:01N | 01:01 | NO_MATCH |
| 5. | 01:AA/01:XX/1 | 01:01 | 01:01 | MATCH |
| 6. | 01:AA/01:XX/1 | 01:01 | 01:01N | MATCH |

### Use Cases for a Multicord Solution

Patient HLA: molecular 01:01

First cord blood unit HLA, which matches the patient: 01:01 and 01:01N

Search in cord blood units, which matches the patient: 01:01 and 01:01N

| | HLA | | | |
|---|---|---|---|---|
| Use | 1 cord blood | | 2 cord blood | |
| case | unit | Search vector* | unit | Match |
| 1. | 01:01 | 01:01 | 01:01 | MATCH |
| 2. | 01:01 | 01:01 | 01:01N | MATCH |
| 3. | 01:01N | 01:01N | 01:01 | MATCH |
| 4. | 01:01N | 01:01 | 01:01N | MATCH |

*secondary information, which is derived from cord blood unit HLA

Patient HLA: molecular 01:01N

First cord blood unit HLA, which matches the patient: 01:01N

Search in cord blood units, which matches the patient: 01:01N

| | HLA | | | |
|---|---|---|---|---|
| Use | 1 cord blood | | 2 cord blood | |
| case | unit | Search vector* | unit | Match |
| 5. | 01:01N | 01:01N | 01:01N | MATCH |

*secondary information, which is derived from cord blood unit HLA

### Minimum Match Grade

It can be specified (and set up in a search profile) that specific HLA-Loci are:

a) Relevant for the matching. The default is that the HLA-loci specified in section 3 are relevant for matching. However the user can specify that certain loci do not need to be considered in the matching.
b) Actual Match for a particular HLA-Locus. The matching results should only contain entries in which the specified locus has an actual match. Any mismatch or potential match for the specified loci means that the CBU will not be included in the matching results.
c) Potential match for a particular HLA-Locus. The matching results should only contain entries in which the specified locus has a potential or actual match. Any mismatch for the specified loci means that the CBU will not be included in the matching results.

### Determining the Search Vector Value Ranking

The values in the search vector are given a rank. When one of the values in the heterozygote pair for a particular HLA locus in a CBU matches one of the values in the search vector, then the CBU is given, for the corresponding pair value, the rank that was specified in the search vector. The ranks are then later summed together and the total value used to determine where the CBU is positioned in the list of matches (i.e. a good ranking is placed higher in the list). The ranking given to a match is determined by the resolution of the molecular and serological codes. Each resolution is assigned a ranking level as shown in the following table:

TABLE 7

| | | |
|---|---|---|
| 1 | High Resolution | |
| 2 | | Associates |
| 3 | Medium Resolution | |
| 4 | Low Resolution | Antigens |
| 5 | | Splits |
| 6 | | Broad |
| 7 | | Possible, assumed and expert assigned |
| | | serological mappings, independent of |
| | | resolution |

Each value in the search vector is then given a ranking that depends on:

a) What the ranking level the original patient value had.
b) What the ranking level is for the value in the search vector.

How the ranking is then determined is shown in the following table:

TABLE 8

| Patient | | | | | | | |
|---|---|---|---|---|---|---|---|
| Ranking | Search Vector Ranking Level | | | | | | |
| Level | 1 | 2 | 3 | 4 | 5 | 6 | 7 |
| 1 | R1 | R2 | R3 | R4 | R5 | R6 | R7 |
| 2 | R2 | R2 | R3 | R4 | R5 | R6 | R7 |
| 3 | R3 | R3 | R3 | R4 | R5 | R6 | R7 |
| 4 | R4 | R4 | R4 | R4 | R5 | R6 | R7 |
| 5 | R5 | R5 | R5 | R5 | R5 | R6 | R7 |
| 6 | R6 | R6 | R6 | R6 | R6 | R6 | R7 |
| 7 | R7 | R7 | R7 | R7 | R7 | R7 | R7 |

Using the ranking levels and the ranking is best illustrated with 2 examples below.

TABLE 9

| | | Ranking | |
|---|---|---|---|
| | Value | Level | Rank |
| Patient | B*51:02:02 | 1 | — |
| Search Vector | B*51:02:02 | 1 | 1 |
| | B*51:BC/BD/ . . . | 3 | 3 |
| | B*51:XX | 4 | 4 |
| | B5102 | 2 | 2 |
| | B51 | 5 | 5 |
| | B5 | 6 | 6 |

In the above table the HLA B locus of the patient has been molecularly typed with a high resolution. This is (from the ranking level table) assigned a ranking level of 1. As described before, a number of values are determined for the search vector. These are assigned a ranking level according to their resolution using Table 7. So, for instance, the high resolution molecular value is assigned a ranking level of 1, whilst the serological associated value (B5102) is assigned a ranking level 2. Using the Table 8 above the ranking levels between the patient and the search vector value are compared and a final ranking obtained. Based on the above example, a CBU with value B*51:02:02 will be placed higher in the results list than one with a serological value of B5102 which in turn will be placed higher that a CBU with value B*51:BD. In the above example, the ranking is the same as the ranking level, due to the fact that the patient has been molecularly typed to a high resolution. However this is not always the case.

TABLE 10

| | | Ranking | |
|---|---|---|---|
| | Value | Level | Rank |
| Patient | B*15:XX | 4 | — |
| Search Vector | B*15:01:02/03/ . . . 16 | 1 | 4 |
| | B*15:02:01/ . . . /04 | | |
| | B*15:04 | | |
| | . . . | | |
| | B*15:AB/AC/AD/ . . . /BC/ . . . | 3 | 4 |
| | B*15:XX | 4 | 4 |
| | B62, B75 | 5 | 5 |
| | B15 | 6 | 6 |

In the example shown in Table 10 the patient has been typed with a low resolution molecular code, B*15:XX. Using the mechanisms described in previous sections, a set of potential high resolution codes are derived from this. Although these are given a ranking level of 1, the actual ranking is only 4, reflecting the fact that the high resolution codes have been derived from a less precise low resolution code. To determine the ranking for the complete CBU the rankings are added together. For instance, the following example shows a CBU with a match grade 5/6. In addition the individual ranking are shown. Summing these together gives a CBU ranking of 12.

| | HLA-A Pair | | HLA-B Pair | | HLA-DRB1 Pair | | |
|---|---|---|---|---|---|---|---|
| | 1. Value | 2. Value | 1. Value | 2. Value | 1. Value | 2. Value | |
| Patient | A*01:08 | A*24:04 | B*52:07 | B*40:03 | DRB1*03:02:01 | DRB1*12:05 | |
| CBU 1 | A1 | A:24:04 | B*27:15 | B*40:03 | DR18 | DRB1*12:05 | |
| Rank | 4 | 1 | — | 1 | 5 | 1 | Σ = 12 |

### Search Vector Structure

All possibly matching values for a patient or a CBU are stored in a structure called “Main Search Vector” (MSV). The MSV consists of a “Value Search Vector” (VSV) for each of the two values of each relevant locus. Currently, this results in six VSV for A,B and DRB1.

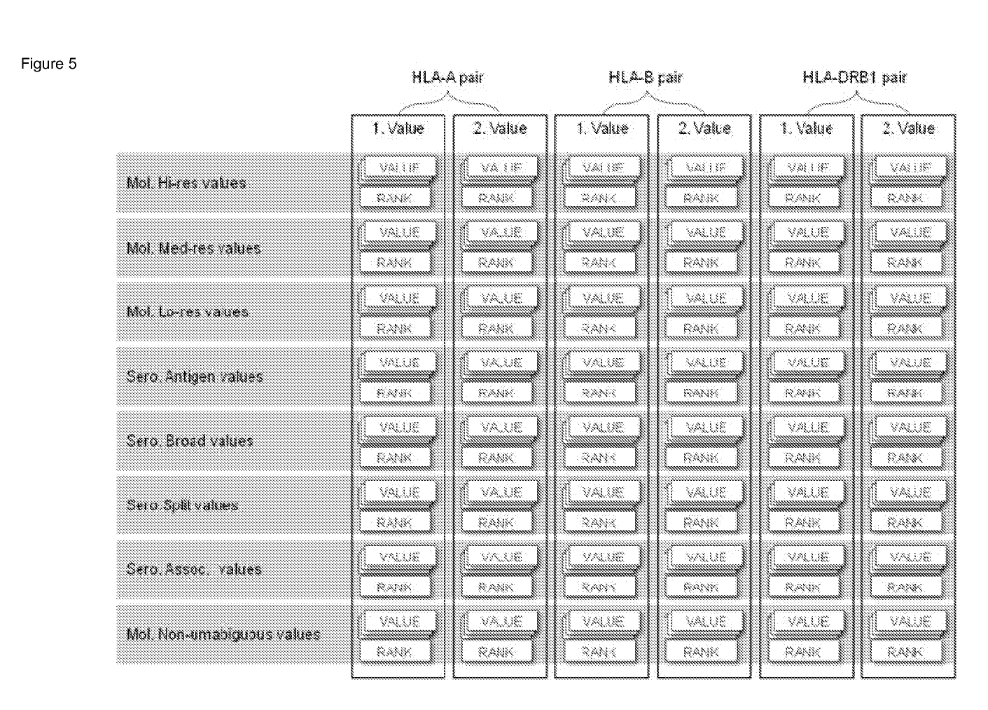

The structure of the complete search vector is shown in FIG. 5. For each HLA locus value and for each possible resolution a number of values (corresponding to the molecular of serological codes) are added.

### Checking Each CBU Against the Patient's Search Vector

Once the Main Search Vector has been prepared with the values derived from each of the patient's values, a search is made through all the CBUs to see if any CBUs have values (for each locus) that match one of the values in the search vector. If one of the values is present then the CBU is added to a results list and tagged with:

a) The rank of the matching code in the search vector
b) If the patient has a molecular high resolution type and the CBU has a high resolution type that is exactly the same then the match is tagged as ACTUAL MATCH. If not, then the match is tagged in the list as POTENTIAL MATCH.

The values of one locus of a CBU have to be compared to the values in the two corresponding Value Search Vectors, meeting the following requirements:
There must only be one match within one VSV for both CBU values.
The best match has to be found. I.e., if there is an Actual Match and a Potential Match for one CBU value, the Actual Match has to be taken. Therefore all four possible combinations between CBU Values and VSVs of one locus have to be considered to find the best match:

| CBU Values | Value Search Vector |
|---|---|
| CBU Locus A Value1 | VSV for Locus A Value 1 |
| CBU Locus A Value 2 | VSV for Locus A Value 2 |

1. CBU Locus A Value1 <-> VSV for Locus A Value 1
2. CBU Locus A Value1 <-> VSV for Locus A Value 2
3. CBU Locus A Value2 <-> VSV for Locus A Value 1
4. CBU Locus A Value2 <-> VSV for Locus A Value 2

### Examples for Matching Patient and CBU Value Pairs:

| Patient value | | |
|---|---|---|
| pair of one | | |
| locus | CBU value pair of one locus | Note |
| 02:01 | 02:02 (actual match) | Both values match, the |
| 02:02 | 02:01 (actual match) | order of the values does not |
| | | matter. |
| 02:01 | 02:01 (actual match) | Only one value matches, |
| 02:01 | 02:02 (no match) | because a CBU value can |
| | | only match to one patient |
| | | value. |
| 02:01 | 02:01 (actual match) | Only one value matches, |
| 02:02 | 02:01 (no match) | because a patient value can |
| | | only match to one CBU |
| | | value |
| 02:01 | 02:AB (->01/02) (potential | Two potential matches, the |
| | match) | |
| 02:02 | 02:AB (->01/02) (potential | value 02:AB was derived |
| | match) | twice for 02:01 and for |
| | | 02:02 in the two Value |
| | | Search Vectors. |
| 02:01 | 02:AB (->01/02) (no match) | Only the value with the |
| 02:03 | 02:01 (actual match) | Actual Match matches |
| | | because a patient value can |
| | | only match to one CBU |
| | | value. |
| 01:01 | 01:01 (actual match) | One actual, one potential |
| 01:AA | 01:01 (potential match) | match. |
| (->01/02/03) | | |
| 01:01 | 01:01 (actual match) | One actual, one potential |
| 01:XX | 01:01 (potential match) | match. |

### Filtering the Results

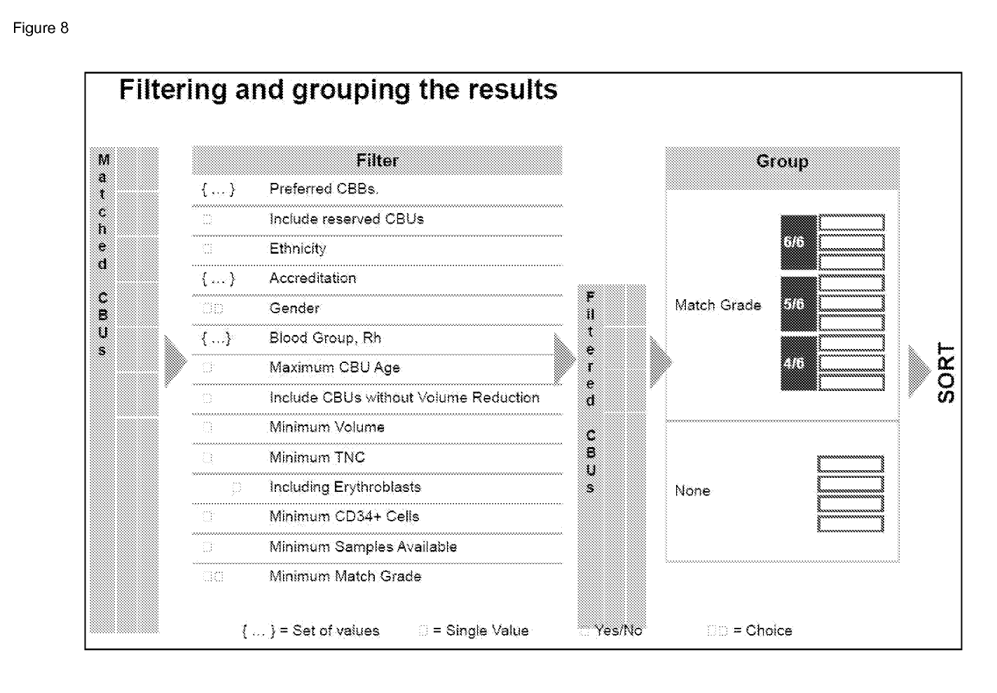

The results are then filtered according to a set of filter criteria (see FIG. 8). These are preferably:

Include reserved CBUs. If this is set to false then reserved CBUs are filtered out (CBU state RESERVED or EXTERNALLY_RESERVED).

Preferred CBBs. This a set of CBBs that are preferred by the user. If a CBU is not from one of the selected preferred CBBs then it is filtered out. If preferred CBBs are not set then CBUs are not filtered out due to the CBB that stores them.

Relevance Matrix. Sets for each locus if the values of the locus have to be:
AM: actual matches
PM: potential matches or actual matches
Relevant: the locus is relevant for calculating the match grades
Not relevant: the locus is not relevant for calculating the match grades

The CBUs are filtered out if they do not match the AM/PM setting for the corresponding locus.

Minimum HLA-Match. Defines the minimum Total Match Grade, e.g. a minimum of 4 means there will be groups of 4/6, 5/6 and 6/6 matches if the loci A, B and DRB1 are relevant for matching. This setting is influenced by the setting of “Rank Potential Matches as Matches”.

Ethnicity. If this is set to false then CBUs that do not have the same ethnicity as the patient are filtered out.

Accreditation. This is a set of accepted accreditations (e.g. FACT, AABB). If the CBU is not stored by a CBB with the specified accreditations then it is filtered out. If no accreditation is specified then no CBU is filtered out due to the accreditation of the CBB storing it.

Gender. If one gender is not specified, then CBUs from patients with that gender are filtered out.

Blood Group. This is a set of blood groups that are required in the search results. If the CBU has a blood group that is not specified then it is filtered out.

Rhesus. This is a set of rhesus factors (positive/negative) that are required in the search results. If the CBU has a rhesus factor that is not specified then it is filtered out.

Maximum CBU Age. If the CBU has an age (in years) that is older than that specified, then it is filtered out. If the age is not relevant then no CBU is filtered out based on its age.

Include CBUs without Volume Reduction. Normally the volume of a CBU is given as two values; before and after volume reduction. If, however, the CBU only specifies its volume before reduction and this flag is set then the CBU will be included in the results.

Minimum volume. CBUs with a volume less than that specified are filtered out.

Depending on the values available for the CBU they shall be used in the following order: Volume after Reduction->Volume before Reduction

Minimum TNC. CBUs with a TNC (not including erythroblasts) less than that specified are filtered out. In addition Including Erythroblasts can also be set to indicate that the minimum TNC includes erythroblasts. In this case only those CBUs whose TNC value including erythroblasts that fall under the specified value will be filtered out. CBUs in which only the TNC value without erythroblasts is recorded will be included and the value considered as including erythroblasts. In this way only CBUs with high TNC values will remain, although it is assumed that the majority of CBUs will record both values. TNC values are in units of 107 cells. Depending on the values available for the CBU they shall be used in the following order: TNC w/o Erythroblasts after Reduction->TNC with erythroblasts after Reduction->TNC w/o erythroblasts before Reduction->TNC with erythroblasts before Reduction.

Minimum CD34+ cells. CBUs with less than the specified number of CD34+ cells (in units of 106 cells) are filtered out.

Depending on the values available for the CBU they shall be used in the following order: CD34+ after Reduction->CD34+ before Reduction

Minimum Samples Available. CBUs with less than the specified number of samples are filtered out. The number of samples is the sum of DNA-Samples and Aliquots.

All filters have to be used as positive filters. This means CBUs that have the selected values have to be included in the result set. Is a CBU value not set this is handled as a match and the CBU is included in the result set. The matching is only performed on CBUs that have one of the status values AVAILABLE, RESERVED or EXTERNALLY_RESERVED. All other CBUs are filtered out and are not relevant for matching. If a filter is not set (i.e. no value is set for filters that allow setting a list of values) no CBU is filtered out concerning this value. (Otherwise the result set would be empty.)

### Grouping the Results

Once the match results have been produced they are preferably grouped according to one of the following criteria (see FIG. 8):

Match Grade. The results are sorted out into different groups depending on how many matches (actual and potential) have been made for each value in each pair for the loci under consideration. For instance, the default is that a group is created in which the CBUs have 6 actual and potential matches (i.e. 6 out of 6 HLA values), another group for 5 out of 6 actual and potential matches (5/6) and a third in which only 4 actual and potential matches are found (4/6). The match grade can be changed by the user so that:
The minimum number of matches can be specified. Setting a minimum of 3, for example, will create a fourth group in which 3 out of 6 (3/6) actual or potential matches are shown. Setting a minimum of 6 means that only one group (6/6) is created.
Potential matches are not considered in the grouping. For instance, CBU in which 4 values are an actual match and 2 values are a potential match would have previously been placed in the 6/6 group; if the potential matches are not considered then this CBU would be placed in the 4/6 group. The default is that potential matches are included in the match grade grouping.

None. No grouping is performed.

### Sorting the Results

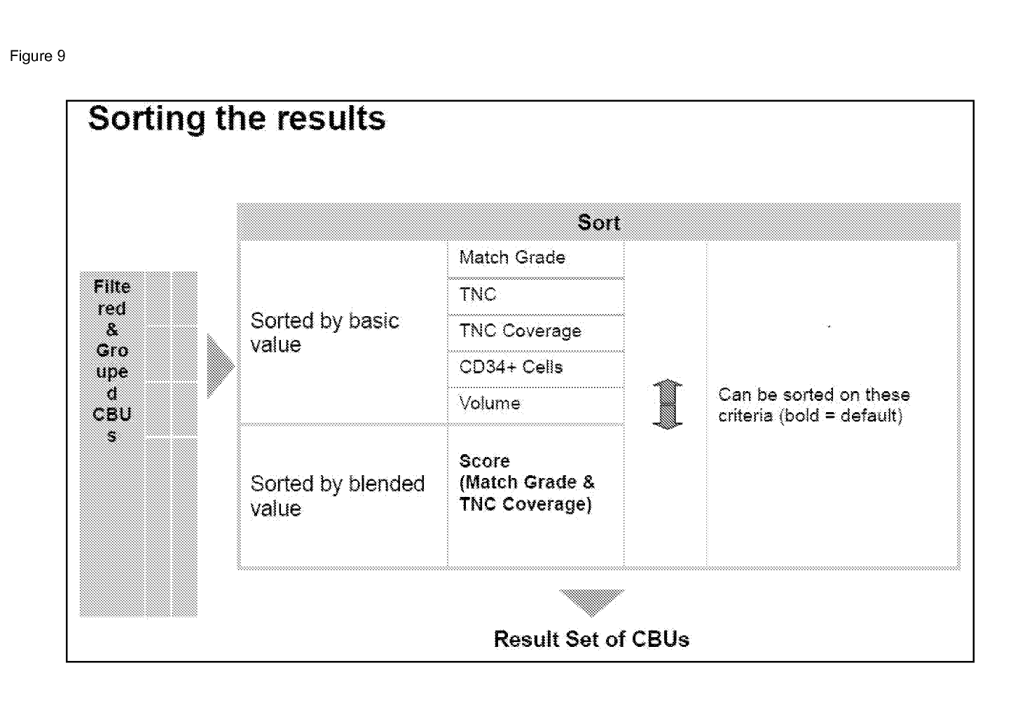

Once the match results have been grouped the results (i.e. the CBUs) are sorted according to a set of selectable criteria (see FIG. 9). The sorting is done within each group, so that the CBUs that score higher according to the sorting criteria are placed higher in that group. For instance, in the following example the CBUs are grouped according to match grade and the TNC value is used to sort them. This means that TNC values of 400 and 350 are shown in the lower 4/6 match group (note that actual matches are shown bold, potential matches as bold italic):

| | | HLA-A pair | | HLA-B pair | | HLA-DRB1 pair | | |
|---|---|---|---|---|---|---|---|---|
| | | 1. value | 2. value | 1. value | 2. value | 1. value | 2. value | TNC |
| | Patient | A*01:08 | A*24:04 | B*52:07 | B*40:03 | DRB1*03:02:01 | DRB1*12:05 | |
| 5/6 | CBU 1 | [symbol] | A:24:04 | B*27:15 | B*40:03 | [symbol] | DRB1*12:05 | 300 |
| | CBU 2 | A*01:08 | A*24:04 | B*52:07 | B*56:02 | [symbol] | DRB1*12:05 | 280 |
| 4/6 | CBU 3 | [symbol] | A:24:04 | B*27:15 | [symbol] | DRB1*08:39 | DRB1*12:05 | 400 |
| | CBU 4 | A*01:08 | A*31:08 | B*52:07 | B*95:XX | [symbol] | DRB1*12:05 | 350 |

If no group is specified then the results are sorted according to the criteria selected, e.g. if no match grade was specified and the sorting should be according to TNC then the above CBUs would be displayed as follows:

| | HLA-A pair | | HLA-B pair | | HLA-DRB1 pair | | |
|---|---|---|---|---|---|---|---|
| | 1 value | 2 value | 1 value | 2 value | 1 value | 2 value | TNC |
| Patient | A*01:08 | A*24:04 | B*52:07 | B*40:03 | DRB1*03:02:01 | DRB1*12:05 | |
| CBU 3 | A1 | A:24:04 | B*27:15 | B61 | DRB1*08:39 | DRB1*12:05 | 400 |
| CBU 4 | A*01:08 | A*31:08 | B*52:07 | B*95:XX | [symbol] | DRB1*12:05 | 350 |
| CBU 1 | A1 | A:24:04 | B*27:15 | B*40:03 | DR18 | DRB1*12:05 | 300 |
| CBU 2 | A*01:08 | A*24:04 | B*52:07 | B*56:02 | [symbol] | DRB1*12:05 | 280 |

The sorting is done by the preferred method or system in the backend and directly in the frontend:

The following sort criteria can be selected for the backend:
Total Match Grade, Score and TNC in descending order. The result list is first sorted to Total Match Grade and in addition CBUs with the same Total Match Grade are sorted according to their score. If several CBUs have an equal score an additional sorting according to the TNC value is done. This is used for the “Manual Search”.
Score and TNC in descending order. If several CBUs have an equal score an additional sorting according to the TNC value is done. This is used for the “Automatic Search”.

The Total Match Grade is the total number of HLA matches. Depending on the search profile settings this is the number of actual matches or the sum of actual and potential matches.

The Score is a blended value calculated by a formula.

The TNC is the total number of nucleated cells. As for the score depending on the values available for the CBU the TNC values shall be used in the following order: TNC w/o Erythroblasts after Reduction->TNC with erythroblasts after Reduction->TNC w/o erythroblasts before Reduction->TNC with erythroblasts before Reduction.

The result list is limited to the first 100 CBUs and provided to the frontend.

The following sort criteria can be selected in the grid of the frontend UI to sort the result list in ascending or descending order:
Score
AM/PM (Actual Matches/Potential Matches)
TNC
Coverage (The ratio of TNC to the patient's weight. The minimum TNC value per kg of the patient's weight is a variable.
Volume
CD34+ Cells

An example of a result set which is sorted by Total Match Grade, Score and TNC is shown below. The sorting to Total Match Grade is used to reflect the grouping in match groups. (note: for clarity, the HLA values are not shown, instead only the ranking given to the HLA matching is shown):

| | Total Match | | TNC | |
|---|---|---|---|---|
| CBU | Grade | Score | Coverage (%) | CD34+ Cells (10⁶) |
| TEST-101 | 6/6 | 100 | 120 | 34 |
| TEST-102 | 6/6 | 90 | 110 | 106 |
| TEST-103 | 6/6 | 80 | 100 | 3 |
| TEST-104 | 6/6 | 70 | 90 | 56 |
| TEST-105 | 5/6 | 90 | 120 | 101 |
| TEST-106 | 5/6 | 80 | 110 | 145 |
| TEST-107 | 5/6 | 70 | 100 | 45 |
| TEST-108 | 5/6 | 60 | 90 | 11 |

Sorting these only to score and TNC gives the following results:

| | Total Match | | TNC | |
|---|---|---|---|---|
| CBU | Grade | Score | Coverage (%) | CD34+ Cells (10⁶) |
| TEST-101 | 6/6 | 100 | 120 | 34 |
| TEST-105 | 5/6 | 90 | 120 | 101 |
| TEST-102 | 6/6 | 90 | 110 | 106 |
| TEST-106 | 5/6 | 80 | 110 | 145 |
| TEST-103 | 6/6 | 80 | 100 | 3 |
| TEST-107 | 5/6 | 70 | 100 | 45 |
| TEST-104 | 6/6 | 70 | 90 | 56 |
| TEST-108 | 5/6 | 60 | 90 | 11 |

### Scoring

In addition, a “Score” value for a blended sort can be specified, In this, the set of values used for sorting are normalized to be between the values 0-100 and the normalized values added together to form a sort factor. The higher the sort factor, the higher the CBU is placed within the selected group. In this way, one sort criteria does not take precedence and the order shows which CBUs are better by taking into consideration a mix of values.

The Score value ranges from 0-100 points and is currently calculated from
Match Grade (50%)
Coverage (50%)

The formula to calculate the Match Grade is:

Match Grade Score

If the Total Match Grade is > 2:

matchScore =

matchResult.getTotalMatch( ) * 10
− 10

− matchResult.getTotalPotentialMatch( ) * 4;

else
matchScore = 0;

This results in the following table:

| | | | Score |
|---|---|---|---|
| Total | | | Match |
| Match | AM | PM | Grade |
| 6 | 6 | 0 | 50 |
| 6 | 5 | 1 | 46 |
| 6 | 4 | 2 | 42 |
| 6 | 3 | 3 | 38 |
| 6 | 2 | 4 | 34 |
| 6 | 1 | 5 | 30 |
| 6 | 0 | 6 | 26 |
| 5 | 5 | 0 | 40 |
| 5 | 4 | 1 | 36 |
| 5 | 3 | 2 | 32 |
| 5 | 2 | 3 | 28 |
| 5 | 1 | 4 | 24 |
| 5 | 0 | 5 | 20 |
| 4 | 4 | 0 | 30 |
| 4 | 3 | 1 | 26 |
| 4 | 2 | 2 | 22 |
| 4 | 1 | 3 | 18 |
| 4 | 0 | 4 | 14 |
| 3 | 3 | 0 | 20 |
| 3 | 2 | 1 | 16 |
| 3 | 1 | 2 | 12 |
| 3 | 0 | 3 | 8 |
| 2 | 2 | 0 | 0 |
| 2 | 1 | 1 | 0 |
| 2 | 0 | 2 | 0 |
| 1 | 1 | 0 | 0 |
| 1 | 0 | 1 | 0 |
| 0 | 0 | 0 | 0 |

### Coverage Score

Due to the loss of cells when processing the CBU the needed coverage of cells for a patient depending on his weight is about 120%. Nevertheless, a CBU with an even greater cell count will be preferred by a physician. Taking this into account the formula will linearly give points for a CBU up to 120% and give some bonus points (10% of the maximum points achievable) for very big units reaching certain defined boundaries. Since very small units will often not be usable, points are only given to units reaching at least a minimal coverage value.

The formula to calculate the Coverage Score currently uses the following boundary values:
MIN_VALUE_TNC_COVERAGE=30%
MAX_VALUE_TNC_COVERAGE=120%
MIN_SCORE_TNC_COVERAGE=1
MAX_SCORE_TNC_COVERAGE=45
MAX_SCORE=50
This means 1 to 45 points are given for a coverage of at least 30% up to the maximum points for a coverage of 120%. Additional 5 points are given for reaching defined boundary values.

scorePerValue =

(MAX_SCORE_TNC_COVERAGE
−MIN_SCORE_TNC_COVERAGE)
/(MAX_VALUE_TNC_COVERAGE −
MIN_VALUE_TNC_COVERAGE);

if (coverage >= MAX_VALUE_TNC_COVERAGE) {

coverageScore = MAX_SCORE_TNC_COVERAGE;

} else if (coverage <= MIN_VALUE_TNC_COVERAGE) {

coverageScore = MIN_SCORE_TNC_COVERAGE;
} else {
coverageScore = Math.round(

```
  (coverage − MIN_VALUE_TNC_COVERAGE) *
  scorePerValue );
```

}
if (coverage > 120%) {

coverageScore = coverageScore + (2% of MAX_SCORE);

}

if (coverage >= 150%) {

coverageScore = coverageScore + (2% of MAX_SCORE);

}

if (coverage >= 200%) {

coverageScore = coverageScore + (2% of MAX_SCORE);

}

if (coverage >= 250%) {

coverageScore = coverageScore + (2% of MAX_SCORE);

}

if (coverage >= 300%) {

coverageScore = coverageScore + (2% of MAX_SCORE);

}

The maximum and minimum score values have to be set explicitly, since the given formula does not calculate these values correctly.

### Note:

The coverage is calculated by:
“TNC of CBU”/“patient weight in kg”*“minimum TNC per kg”

To calculate the coverage value from the TNC of the CBU the same fallback values as for the TNC calculation shall be used: Depending on the values available for the CBU they shall be used in the following order: TNC w/o Erythroblasts after Reduction->TNC with erythroblasts after Reduction->TNC w/o erythroblasts before Reduction->TNC with erythroblasts before Reduction.

### Score

The complete Score value for a CBU is calculated by summing up the Match Grade Score and the Coverage Score of the CBU.

### Advanced Scoring

In future an advanced scoring mechanism may replace the described basic scoring. In this case the score includes the ranking information and normalized values as described below.

The normalized value is calculated by taking the average of all the values for a sort criteria (e.g. TNC Coverage) and then dividing the actual result by this average. This is then multiplied by 100, i.e.

$$normalised {value}_{i} = \frac{{value}_{i} \times 100}{avg ( {value}_{1} … {value}_{n} )}$$

Rankings are handled differently. As a better ranking has lower value, the reciprocal is used, i.e.

$$normalised {ranking}_{i} = \frac{avg ( {ranking}_{1} … {ranking}_{n} ) \times 100}{{ranking}_{i}}$$

The sort criteria for a blended sort are preset and correspond to the sort criteria used for the default ordering, i.e.:

Match ranking, TNC Coverage, CD34+ cells

An example of a sorted list is shown below (together with the averages, normalized values and score factors):

| | | | | | | | Normalised | |
|---|---|---|---|---|---|---|---|---|
| | | | | | Normalised | Normalised | CD34+ | Sorting |
| | | | | | Ranking | TNC Coverage | Cells | Factor |
| TEST-102 | 6/6 | 6 | 100 | 106 | 419 | 91 | 153 | 663 |
| TEST-105 | 6/6 | 8 | 120 | 58 | 314 | 109 | 84 | 507 |
| TEST-106 | 6/6 | 43 | 200 | 100 | 58 | 181 | 145 | 384 |
| TEST-101 | 6/6 | 12 | 98 | 34 | 210 | 89 | 49 | 348 |
| TEST-107 | 6/6 | 30 | 110 | 98 | 84 | 100 | 142 | 325 |
| TEST-104 | 6/6 | 22 | 120 | 56 | 114 | 109 | 81 | 304 |
| TEST-103 | 6/6 | 42 | 40 | 3 | 60 | 36 | 4 | 100 |
| TEST-110 | 5/6 | 27 | 210 | 120 | 93 | 190 | 174 | 457 |
| TEST-113 | 5/6 | 12 | 140 | 45 | 210 | 127 | 65 | 402 |
| TEST-112 | 5/6 | 45 | 130 | 145 | 56 | 118 | 210 | 384 |
| TEST-111 | 5/6 | 34 | 120 | 101 | 74 | 109 | 146 | 329 |
| TEST-108 | 5/6 | 20 | 45 | 56 | 126 | 41 | 81 | 248 |
| TEST-109 | 5/6 | 31 | 67 | 34 | 81 | 61 | 49 | 191 |
| TEST-114 | 5/6 | 20 | 45 | 11 | 126 | 41 | 16 | 182 |
| Sum | | 25.14 | 110.36 | 69.07 | | | | |

### Multicord Matching

Multicord matching uses the same matching principle as that between patient and CBU, but takes as its base the set of CBUs that matched the patient with 4, 5 or 6 actual and potential matches (i.e. 4/6, 5/6/or 6/6) and matches these against the first selected CBU. The ranking, filtering, grouping and ordering is also the same as before, with the exception of the default match grade minimum (between CBUs) which is set to 4.

The method or systems preferably uses the following data sources:

| SER-SER | Mappings between | http://hla.alleles.org/wmda/rel_ser_ser.txt |
|---|---|---|
| | serological broad | |
| | antigens, split antigens | |
| | and associated | |
| | antigens. | |
| DNA-SER | Mapping between | http://hla.alleles.org/wmda/rel_dna_ser.txt |
| | molecular types alleles | |
| | and equivalent | |
| | serological antigens. | |
| ALLELE-CODE-LIST | Specification of the | http://bioinformatics.nmdp.org/HLA/ |
| | molecular typing | Allele_Codes/Allele_Code_Lists/index.html |
| | medium resolution | |
| | codes. | |
| NOMENCLATURE_2009 | Contains a mapping | http://hla.alleles.org/data/txt/Nomenclature_2009.txt |
| | between the old | |
| | molecular codes and | |
| | the new one to be | |
| | introduced in April | |
| | 2010. | |

1. Method for the identification and selection for at least one cord blood unit for a transplantation, comprising:
a. inputting serological and/or molecular codes of HLA loci, allele type and further criteria of the cord blood unit,
b. inputting serological and/or molecular codes of HLA loci and allele type and further criteria of a recipient,
c. converting inputs of a. and b. into a standardized nomenclature,
d. generating a search vector, which contains all possible values matching the serological and/or molecular nomenclature of the HLA loci and allele type of the recipient, and wherein a possible value is assigned a ranking that determines where a unit appears in the results list, and wherein the ranking depends on the match between the HLA loci and allele type of the possible unit and the recipient,
e. comparing the HLA loci and allele type of the search vector with the input according to a,
f. generating a list comprising possible cord blood units for the recipient together with previously determined ranking in the search vector,
g. filtering the list in accordance to a set of defined criteria based on parameters of the cord blood unit and/or the recipient,
h. grouping the possible units according to the match grade and
i. sorting the units in accordance with at least the match grade.

2. Method according to claim 1, wherein the loci is chosen from the group consisting of HLA-A, -B, -C, -DR, -DP and -DQ.

3. Method according to claim 1, wherein the criteria comprises data about the cord blood donor, the cord blood unit and the recipient selected from the group consisting of ethnicity, accreditation, blood group, rhesus factor, diseases, genetic defects, cord blood unit age and volume of cord blood.

4. Method according to claim 1, wherein the molecular codes are categorized in a standardized nomenclature comprising
a. high resolution, in which the allele is directly specified,
b. medium resolution, in which a range of possible values is given, and
c. low resolution, in which only the HLA locus and allele type is specified.

5. Method according to claim 1, wherein the serological codes are categorized in a standardized nomenclature comprising
a. antigen,
b. broad,
c. split and
d. associate.

6. Method according to claim 1, wherein molecular codes can be compensated by serological codes and vice versa.

7. Method according to claim 1, wherein method identifies cord blood units for an allotransplantation.

8. Method according to claim 1, wherein identified cord blood units can be combined to multicord transplants.

9. Method according to claim 1, wherein the cord blood units are characterized by the following parameters:
name and identification of the UCB storage bank (UCB bank),
status of the UCB storage bank with regard to international certifications, preferably FACT,
process reliability of the UCB bank according to classification,
contact in the respective bank, including contact data,
identification number of preparation,
medical history of mother, child and family according to anamnesis form of the maternity clinic,
ethnic group of mother, father and/or child,
sex of child,
date of initial storage of preparation,
details of preparation processing,
blood group of preparation,
HLA type of preparation,
cell count (TNC) of preparation,
cell count (CD34+) of preparation,
viral status of preparation,
allelic characteristics of preparation, and/or
parameters of molecular diagnoses and analyses,
said data set being stored on a storage medium and/or processing unit.

10. Method according to claim 1, wherein the recipient is characterized by the following parameters:
name and identification of clinic or transplantation center,
names of coordinator and attending physician, including contact data,
status of clinic with regard to international certifications (e.g. FACT),
average number of UCB transplantations in the inquiring clinic during the last three years,
name of patient, insurance number and other accounting information,
patient's medical history,
indication and therapy proposal of attending physician,
urgency according to defined classification,
HLA type of patient,
blood group of patient,
weight of patient,
ethnic group of patient,
sex of patient,
age of patient,
known allelic characteristics of patient and/or data of DNA typing, and/or
first treatment or re-treatment,
said classification and/or exclusion criteria being stored on a storage medium and/or processing unit.

11. System for identification and selection for at least one cord blood unit for a transplantation wherein the system comprises one or more processing units, wherein said one or more processing units are configured to:
a. store on a storage medium serological and/or molecular codes of HLA loci, allele type and further criteria of the cord blood unit inputted into a computer,
b. store on a storage medium serological and/or molecular codes of HLA loci and allele type and further criteria of a recipient inputted into a computer,
c. converting the inputs according to a. and b. into a standardized nomenclature,
d. generating a search vector, which contains all possible values matching the serological and/or molecular nomenclature of the HLA loci and allele type of the recipient, and wherein a possible value is assigned a ranking that determines where a unit appears in the results list, and wherein the ranking depends on the match between the HLA loci and allele type of the possible unit and the recipient, particularly the storage of said search criteria on a storage medium and/or a processing unit,
e. comparing the HLA loci and allele type of the search vector with a,
f. generating a list comprising possible cord blood units for the recipient together with the previously determined ranking in the search vector,
g. filtering the list in accordance to a set of defined criteria,
h. grouping the possible units according to the match grade and
i. sorting the units in accordance with at least the match grade.

12. Method for an identification of at least one matching cord blood unit for a patient in need of such a transplant comprising:
providing the system of claim 11, and identifying at least one matching cord blood unit for a patient in need of such a transplant.
